(19) United States
(12) Patent Application Publication
(10) Pub. No.: US 2026/0362524 A1
(43) Pub. Date: Nov. 12, 2026

(54) MULTI-LINK AIDED BEAM TRAINING FOR INTEGRATED MILLIMETER WAVE OPERATION

(71) Applicant: QUALCOMM Incorporated, San Diego, CA (US)

(72) Inventors: Abhishek Pramod PATIL, San Diego, CA (US); George CHERIAN, San Diego, CA (US); Giovanni CHISCI, San Diego, CA (US)

(21) Appl. No.: 19/668,588

(22) Filed: May 5, 2026

Related U.S. Application Data
(60) Provisional application No. 63/804,571, filed on May 12, 2025.

(51) Int. Cl. H04W 76/15; H04W 24/08

(52) U.S. Cl. CPC H04W 76/15; H04W 24/08

(57) ABSTRACT

This disclosure provides methods, components, devices, and systems for multi-link (ML) aided beam training for integrated millimeter wave (IMMW) operation. Some aspects more specifically relate to communicating information via a first link that supports functionality for a second link while operating according to multi-link operation (MLO). In some examples, an access point (AP) multi-link device (MLD) may transmit, via a first link corresponding to a first frequency band associated with omni-directional communications, a frame that indicates timing information for a second frequency band associated with directional communications. A non-AP MLD may receive the frame and monitor the second frequency band for one or more AP sector reference (ASR) messages based on the timing information. The non-AP MLD may use a received ASR message to determine reachability of the AP MLD, update a link, an ML association, or both between the MLDs, perform communication beam training, or any combination thereof.

### CROSS REFERENCE

The present Application for Patent claims the benefit of U.S. Provisional Patent Application No. 63/804,571 by Patil et al., entitled “MULTI-LINK AIDED BEAM TRAINING FOR INTEGRATED MILLIMETER WAVE OPERATION,” filed May 12, 2025, assigned to the assignee hereof, and expressly incorporated by reference herein.

### TECHNICAL FIELD

This disclosure relates generally to wireless communication and, more specifically, to multi-link (ML) aided beam training for integrated millimeter wave (IMMW) operation.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a non-access point (AP) multi-link device (MLD) for wireless communication. The non-AP MLD may include a processing system that includes processor circuitry and memory circuitry that stores code. The processing system may be configured to cause the non-AP MLD to receive, via a first link corresponding to a first frequency band associated with omni-directional communications, a frame that indicates information (e.g., timing information) for a second frequency band associated with directional communications and monitor the second frequency band for a message (e.g., an AP sector reference (ASR) message) based on the information, where the ASR message corresponds to a beam direction for the directional communications at an AP MLD. In some examples, the message may indicate a transmit power of the message, a sector ID, a basic service set (BSS) color, an AP identifier (ID), or a partial or full timing synchronization function (TSF) value, or any combination thereof. The processing system may be further configured to cause the non-AP MLD to communicate with the AP MLD based on the monitoring.

Another innovative aspect of the subject matter described in this disclosure can be implemented in a method for wireless communication at a non-AP MLD. The method may include receiving, via a first link corresponding to a first frequency band associated with omni-directional communications, a frame that indicates information (e.g., timing information) for a second frequency band associated with directional communications and monitoring the second frequency band for a message (e.g., an ASR message) based on the information, where the message corresponds to a beam direction for the directional communications at an AP MLD. In some examples, the message may indicate a transmit power of the message, a sector ID, a BSS color, an AP ID, or a partial or full TSF value, or any combination thereof. The method may further include communicating with the AP MLD based on the monitoring.

Another innovative aspect of the subject matter described in this disclosure can be implemented in another non-AP MLD. The non-AP MLD may include means for receiving, via a first link corresponding to a first frequency band associated with omni-directional communications, a frame that indicates information (e.g., timing information) for a second frequency band associated with directional communications and means for monitoring the second frequency band for a message (e.g., an ASR message) based on the information, where the message corresponds to a beam direction for the directional communications at an AP MLD. In some examples, the message may indicate a transmit power of the message, a sector ID, a BSS color, an AP ID, or a partial or full TSF value, or any combination thereof. The non-AP MLD may further include means for communicating with the AP MLD based on the monitoring.

Another innovative aspect of the subject matter described in this disclosure can be implemented in a non-transitory computer-readable medium storing code for wireless communication. The code may include instructions executable by one or more processors to receive, via a first link corresponding to a first frequency band associated with omni-directional communications, a frame that indicates information (e.g., timing information) for a second frequency band associated with directional communications and monitor the second frequency band for a message (e.g., an ASR message) based on the information, where the message corresponds to a beam direction for the directional communications at an AP MLD. In some examples, the message may indicate a transmit power of the message, a sector ID, a BSS color, an AP ID, or a partial or full TSF value, or any combination thereof. The code may further include instructions executable by the one or more processors to communicate with the AP MLD based on the monitoring.

Some examples of the method, non-AP MLDs, and non-transitory computer-readable medium described herein may further include operations, features, means, or instructions for receiving, via the second frequency band, the message based on the monitoring and determining a reachability of a second link corresponding to the second frequency band based on a receive power of the message, a transmit power of the message, or both.

Some examples of the method, non-AP MLDs, and non-transitory computer-readable medium described herein may further include operations, features, means, or instructions for receiving, via the second frequency band, the message based on the monitoring and establishing a multi-link (ML) association between the non-AP MLD and the AP MLD that includes a second link corresponding to the second frequency band based on the message. Some other examples of the method, non-AP MLDs, and non-transitory computer-readable medium described herein may further include operations, features, means, or instructions for receiving, via the second frequency band, the message based on the monitoring and adding a second link corresponding to the second frequency band to an ML association between the non-AP MLD and the AP MLD based on the message. Yet some other examples of the method, non-AP MLDs, and non-transitory computer-readable medium described herein may further include operations, features, means, or instructions for deleting a second link corresponding to the second frequency band from an ML association between the non-AP MLD and the AP MLD based on failing to receive, via the second frequency band, the message based on the monitoring or receiving, via the second frequency band, the message with a receive power that fails to satisfying a reachability threshold based on the monitoring.

Some examples of the method, non-AP MLDs, and non-transitory computer-readable medium described herein may further include operations, features, means, or instructions for receiving, via the second frequency band, one or more messages based on the monitoring and performing communication beam training for a second link corresponding to the second frequency band based on the one or more messages.

In some examples of the method, non-AP MLDs, and non-transitory computer-readable medium described herein, the information indicates a transmission period (e.g., an ASR transmission period (ATP)) for the AP MLD and the second frequency band may be monitored during at least a portion of the transmission period.

In some examples of the method, non-AP MLDs, and non-transitory computer-readable medium described herein, the first frequency band includes a sub-7 Gigahertz (GHz) band and the second frequency band includes a 60 GHz band, a 45 GHz band, or a 28 GHz band.

Another innovative aspect of the subject matter described in this disclosure can be implemented in an AP MLD for wireless communication. The AP MLD may include a processing system that includes processor circuitry and memory circuitry that stores code. The processing system may be configured to cause the AP MLD to transmit, via a first link corresponding to a first frequency band associated with omni-directional communications, a frame that indicates information (e.g., timing information) for a second frequency band associated with directional communications and transmit, via the second frequency band, a set of multiple messages (e.g., ASR messages) based on the information, where each message of the set of multiple messages corresponds to a respective beam direction for the directional communications at the AP MLD. In some examples, each message indicates a respective message transmit power, a respective sector ID, a respective BSS color, a respective AP ID, or a respective partial or full TSF value, or any combination thereof. The processing system may be further configured to cause the AP MLD to communicate with a non-AP MLD based on at least one message of the set of multiple messages.

Another innovative aspect of the subject matter described in this disclosure can be implemented in a method for wireless communication at an AP MLD. The method may include transmitting, via a first link corresponding to a first frequency band associated with omni-directional communications, a frame that indicates information (e.g., timing information) for a second frequency band associated with directional communications and transmitting, via the second frequency band, a set of multiple messages (e.g., ASR messages) based on the information, where each message of the set of multiple messages corresponds to a respective beam direction for the directional communications at the AP MLD. In some examples, each message indicates a respective message transmit power, a respective sector ID, a respective BSS color, a respective AP ID, or a respective partial or full TSF value, or any combination thereof. The method may further include communicating with a non-AP MLD based on at least one message of the set of multiple messages.

Another innovative aspect of the subject matter described in this disclosure can be implemented in another AP MLD. The AP MLD may include means for transmitting, via a first link corresponding to a first frequency band associated with omni-directional communications, a frame that indicates information (e.g., timing information) for a second frequency band associated with directional communications and means for transmitting, via the second frequency band, a set of multiple messages (e.g., ASR messages) based on the information, where each message of the set of multiple messages corresponds to a respective beam direction for the directional communications at the AP MLD. In some examples, each message indicates a respective message transmit power, a respective sector ID, a respective BSS color, a respective AP ID, or a respective partial or full TSF value, or any combination thereof. The AP MLD may further include means for communicating with a non-AP MLD based on at least one message of the set of multiple messages.

Another innovative aspect of the subject matter described in this disclosure can be implemented in a non-transitory computer-readable medium storing code for wireless communication. The code may include instructions executable by one or more processors to transmit, via a first link corresponding to a first frequency band associated with omni-directional communications, a frame that indicates information (e.g., timing information) for a second frequency band associated with directional communications, transmit, via the second frequency band, a set of multiple messages (e.g., ASR messages) based on the information, where each message of the set of multiple messages corresponds to a respective beam direction for the directional communications at the AP MLD. In some examples, each message indicates a respective message transmit power, a respective sector ID, a respective BSS color, a respective AP ID, or a respective partial or full TSF value, or any combination thereof. The code may further include instructions executable by the one or more processors to communicate with a non-AP MLD based on at least one message of the set of multiple messages.

Some examples of the method, AP MLDs, and non-transitory computer-readable medium described herein may further include operations, features, means, or instructions for establishing an ML association between the AP MLD and the non-AP MLD that includes a second link corresponding to the second frequency band based on the at least one message. Some other examples of the method, AP MLDs, and non-transitory computer-readable medium described herein may further include operations, features, means, or instructions for adding a second link corresponding to the second frequency band to an ML association between the AP MLD and the non-AP MLD based on the at least one message. Yet some other examples of the method, AP MLDs, and non-transitory computer-readable medium described herein may further include operations, features, means, or instructions for deleting a second link corresponding to the second frequency band from an ML association between the AP MLD and the non-AP MLD based on the at least one message.

Some examples of the method, AP MLDs, and non-transitory computer-readable medium described herein may further include operations, features, means, or instructions for performing communication beam training for a second link corresponding to the second frequency band based on the set of multiple messages.

Some examples of the method, AP MLDs, and non-transitory computer-readable medium described herein may further include operations, features, means, or instructions for monitoring the second frequency band during an ATP of another AP MLD, detecting one or more messages associated with the other AP MLD based on the monitoring, the one or more messages further associated with one or more sectors at the AP MLD, and scheduling communications for the one or more sectors at the AP MLD based on detecting the one or more messages. Some examples of the method, AP MLDs, and non-transitory computer-readable medium described herein may further include operations, features, means, or instructions for communicating, with the other AP MLD via the first frequency band, a coordination frame that indicates the one or more sectors, scheduling information for the one or more sectors, or both.

Details of one or more implementations of the subject matter described in this disclosure are set forth in the accompanying drawings and the description below. Other features, aspects, and use cases will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling configuration that supports multi-link (ML) aided beam training for integrated millimeter wave (IMMW) operation.

FIG. 6 shows an example of a timeline that supports ML aided beam training for IMMW operation.

FIG. 7 shows an example of a signaling timeline that supports ML aided beam training for IMMW operation.

FIGS. 8A, 8B, and 8C show examples of handling wireless STA mobility that support ML aided beam training for IMMW operation.

FIG. 9 shows an example of AP coordination that supports ML aided beam training for IMMW operation.

FIGS. 10 and 11 show block diagrams of example wireless communication devices that support ML aided beam training for IMMW operation.

FIG. 12 shows a flowchart illustrating an example process performable by or at a non-AP multi-link device (MLD) that supports ML aided beam training for IMMW operation.

FIG. 13 shows a flowchart illustrating an example process performable by or at an AP MLD that supports ML aided beam training for IMMW operation.

Like reference numbers and designations in the various drawings indicate like elements.

Additional disclosure and examples relating to the present description are provided in the attached appendix.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, some wireless devices may support multi-link operation (MLO). For example, an access point (AP) multi-link device (MLD) may establish and maintain multiple wireless links concurrently (e.g., using a multi-link (ML) association). A wireless station (STA), such as a non-AP MLD (e.g., a STA MLD) may similarly establish and maintain multiple wireless links concurrently. In some examples, an AP MLD and a non-AP MLD may communicate via links that operate within different frequency bands. For example, the AP MLD and the non-AP MLD may support a first link via a first frequency band (e.g., a sub-7 gigahertz (GHz)) and a second link via a second frequency band (e.g., a relatively higher frequency band, such as a 60 GHz frequency band, a 45 GHz frequency band, or a 28 GHz frequency band). In some examples, the first link may support omni-directional signaling (e.g., non-beam-based communications), while the second link may support directional signaling (e.g., beam-based communications).

In some cases, establishing (e.g., setting up) a directional link (e.g., a wireless link via the second frequency band) may involve significant latency, signaling overhead, or both. For example, to coordinate timing for beam training or other similar operations for the second frequency band, the AP MLD may transmit multiple frames in multiple different directions (e.g., using multiple different beams) via the second frequency band. A non-AP MLD located in a specific direction from the AP MLD may receive the frame if the AP MLD transmits the frame using a communication beam directed towards the non-AP MLD and if the non-AP MLD monitors for the frame using a communication beam directed towards the AP MLD. Otherwise, the non-AP MLD may fail to receive the frame, reducing reliability and increasing latency associated with establishing the directional link via the second frequency band (e.g., the 60 GHz frequency band). Additionally, or alternatively, in some cases, the non-AP MLD may detect a frame transmitted from an AP MLD at a relatively low receive power and may perform a link establishment procedure with the AP MLD via the second frequency band. However, if the path loss between the AP MLD and the non-AP MLD significantly affects the communications between the AP MLD and the non-AP MLD, the established link may be unreliable, support low throughput, or both. For example, despite detecting the frame, the non-AP MLD may be located outside a range (e.g., according to a reachability metric) of the AP MLD that supports communications which satisfy a signal strength threshold, a signal quality threshold, or both.

Various aspects relate generally to ML-aided functionality for IMMW operation. Some aspects more specifically relate to communicating information via a first link that supports functionality for a second link while operating according to MLO. In some examples, an AP MLD may transmit, via a first link corresponding to a first frequency band (e.g., a sub7 GHz frequency band or other frequency band associated with omni-directional communications), a frame that indicates information (e.g., timing information) for a second frequency band (e.g., a 60 GHz frequency band or other frequency band associated with directional communications). The information may indicate a time window during which the AP MLD may transmit a set of AP sector reference (ASR) messages (e.g., ASR frames) via the second frequency band using directional communications. For example, the AP MLD may transmit multiple ASR messages, where each ASR message corresponds to a respective beam direction for the AP MLD. In some examples, the time window may be an example of an ASR transmission period (ATP), a service period (e.g., a dedicated service period (D-SP) or on-demand service period (O-SP)), or any other time at which the AP MLD may transmit one or more ASR messages. A non-AP MLD may receive the frame indicating the information and may monitor the second frequency band during the time window for one or more ASR messages. If the non-AP MLD receives an ASR message, the non-AP MLD may perform one or more operations for a potential second link (e.g., a link corresponding to the second frequency band) based on the ASR message.

In some examples, the non-AP MLD may use one or more received ASR messages to determine reachability of the AP MLD, to update a link, an ML association, or both between the non-AP MLD and the AP MLD, to perform communication beam training, or any combination thereof. For example, the non-AP MLD may calculate (e.g., determine, or otherwise ascertain) a reachability of the AP MLD via the second frequency band based on a received ASR message. The reachability may indicate whether the non-AP MLD is currently within range of the AP MLD for communications via the second frequency band. The non-AP MLD may determine the reachability based on a receive power (e.g., a receive power measurement) of the ASR message at the non-AP MLD, a transmit power used for the ASR message at the AP MLD, a transmit power supported by the non-AP MLD, or any combination thereof. Additionally, or alternatively, the non-AP MLD may use a received ASR message to establish an ML association between the non-AP MLD and the AP MLD, to add a link (e.g., a link corresponding to the second frequency band) to an existing ML association, to remove a link from the existing ML association, or any combination thereof. Additionally, or alternatively, the non-AP MLD may use one or more received ASR messages to perform beam training for a link corresponding to the second frequency band. For example, the non-AP MLD and the AP MLD may select communication beams for communication that correspond to the ASR message received by the non-AP MLD with the relatively greatest receive power. The beam training may be an initial beam training or a beam update.

In some examples, if the receive power metrics for ASR messages change based on mobility of the non-AP MLD, the non-AP MLD may use the receive power metrics to determine whether the mobility has caused a change in orientation between the non-AP MLD and the AP MLD or the non-AP MLD has moved away from the AP MLD (e.g., outside the reachability or range of the AP MLD for the second frequency band). If the mobility corresponds to a change in orientation between the non-AP MLD and the AP MLD, the non-AP MLD may trigger a beam change. If the mobility corresponds to a loss of reachability via the 60 GHz link, the non-AP MLD may trigger deleting the 60 GHz link and falling back to a sub 7 link (or may search for a different link with another AP MLD). Additionally, or alternatively, AP MLDs may monitor for ASR messages transmitted by other AP MLDs (e.g., neighboring AP MLDs) to detect directions or sectors in which the AP MLDs may experience inter-AP interference. An AP MLD that detects an ASR message from another AP MLD may schedule transmissions to mitigate interference from the other AP MLD, may transmit information to the other AP MLD to support coordinated scheduling between the AP MLDs, or both.

In some examples, by communicating information (e.g., timing information) for the second frequency band using a frame sent via the first frequency band, the wireless devices may improve the performance of a wireless link that uses directional communications (e.g., highly directional beamformed communications). For example, by using an omni-directional link (e.g., rather than a directional link) to transmit timing information for the directional link, the non-AP MLD may, with relatively low latency, reliably determine a time window during which the AP MLD transmits ASR messages, improving coordination between the non-AP MLD and the AP MLD. Additionally, or alternatively, by using an ASR message to determine reachability, the non-AP MLD may determine whether a link via the second frequency band is currently supported between the non-AP MLD and the AP MLD. For example, if the non-AP MLD detects an ASR message, but the non-AP MLD is currently located outside a reliable range of the AP MLD (e.g., a range supporting a threshold signal quality, a threshold signal strength, or both), the non-AP MLD may refrain from attempting to establish a link via the second frequency band based on the determined reachability, reducing a processing overhead and avoiding relatively poor link quality. The non-AP MLD may improve a processing overhead and latency associated with establishing the link via the second frequency band based on the relatively small sizes of the ASR frames. In some examples, the non-AP MLD may improve directional communications by using ASR frames to perform communication beam training. For example, the non-AP MLD may determine a direction for communicating with the AP MLD based on which ASR frame is received with a relatively greatest receive power, improving beam selection and, correspondingly, communication throughput for the MLDs. Additionally, or alternatively, AP MLDs may improve coordination across the wireless network (e.g., between APs) by monitoring for ASR messages from other AP MLDs and adjusting scheduling of communications based on detected ASR messages. Such coordination may reduce or otherwise mitigate potential interference caused by AP MLDs transmitting directional communications towards each other using partially or fully overlapping resources.

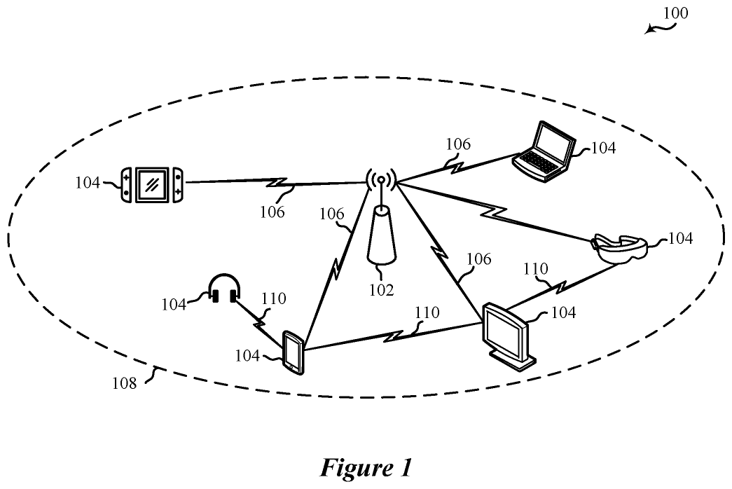

FIG. 1 shows a pictorial diagram of an example wireless communication network 100. According to some aspects, the wireless communication network 100 can be an example of a WLAN such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including an AP 102 and any number of STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHz (sub 7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communication network 100) may use IMMW techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

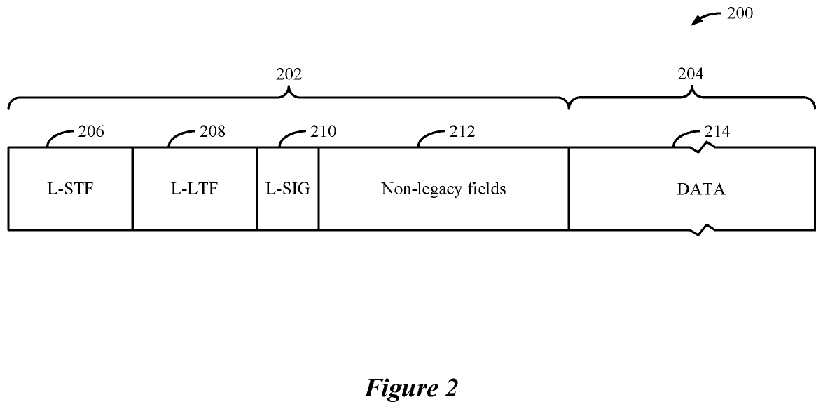

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

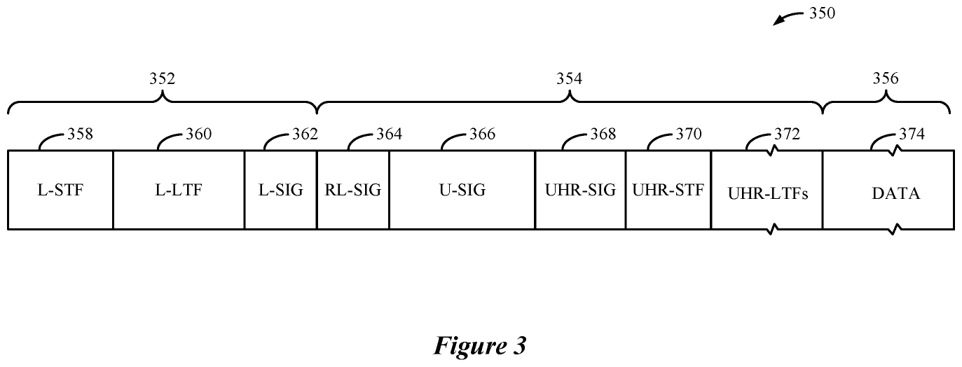

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and wireless devices may use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

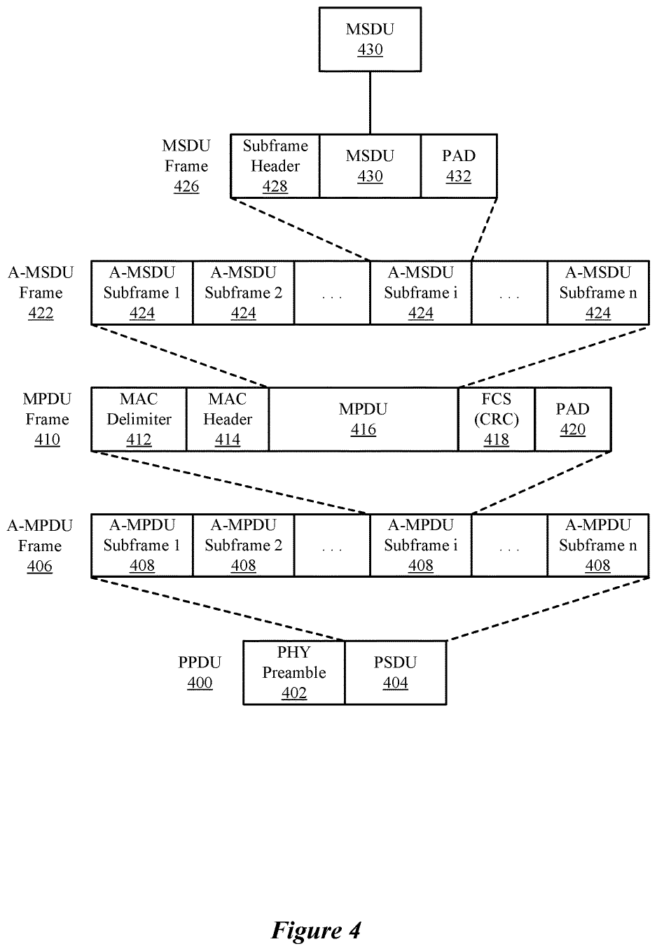

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some APs and STAs, such as, for example, the AP 102 and STAs 104 described with reference to FIG. 1, are capable of MLO. For example, the AP 102 and STAs 104 may support MLO as defined in one or both of the IEEE 802.11be and 802.11bn standard amendments. An MLO-capable device may be referred to as an MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

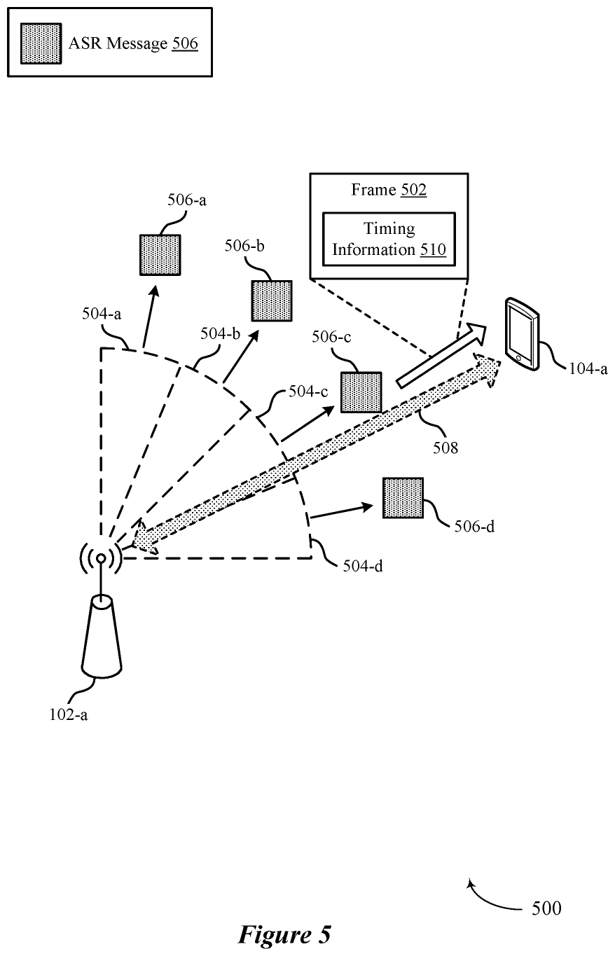

FIG. 5 shows an example of a signaling configuration 500 that supports ML aided beam training for IMMW operation. The signaling configuration 500 may include an AP 102-a and a STA 104-a. The AP 102-a may be an example of an AP 102, as described with reference to FIG. 1, that supports MLO. Similarly, the STA 104-a may be an example of a STA 104, as described with reference to FIG. 1, that supports MLO. For example, the AP 102-a may be an example of an AP MLD and the STA 104-a may be an example of a non-AP MLD (e.g., a STA MLD). The AP 102-a and the STA 104-a may support multiple wireless links via the same frequency band, different frequency bands, or a combination thereof. In some examples, the AP 102-a may support signaling information via a first frequency band to support operations via a second frequency band. For example, the AP 102-a may communicate information via a sub7 frequency band (e.g., or any other frequency band that uses omni-directional communications) to support operations via a relatively higher frequency band (e.g., a 60 GHz frequency band, a 45 GHz frequency band, a 28 GHz frequency band, or any other frequency band that uses directional communications).

Some frequency bands may suffer from relatively high path loss. For example, the 60 GHz frequency band (or other similar frequency bands) may suffer from relatively high path loss, such that communicating via the 60 GHz frequency band may involve using directional communications to mitigate (or otherwise account for) the relatively high path loss. For example, wireless devices communicating via the 60 GHz frequency band may use relatively highly directional communication beams to support a link 508 between the wireless devices. To maintain the link 508, the wireless devices may perform beam training (e.g., regularly, according to a schedule, based on mobility or time) to perform an initial beam training and/or update the directionality of the communication beams.

In some examples, a non-AP STA (e.g., a non-AP MLD, such as the STA 104-a) may use the MLO framework to discover and set up a directional link (e.g., a 60 GHz link) using communications via an omni-directional link (e.g., a sub7 link). A directional link may use beamformed communications, while an omni-directional link may not use beamformed communications. In some implementations, the STA 104-a may discover and set up the directional link without transmitting any frames via the directional link (e.g., via the 60 GHz frequency band). In some implementations, the STA 104-a may perform beam training for the directional link after completing ML setup for the directional link. The omni-directional link may further aid in facilitating the beam training for the directional link, including initial beam training (e.g., after ML setup or association), beam maintenance (e.g., beam updates), or both. Additionally, or alternatively, the omni-directional link may support the STA 104-a determining reachability for the directional link from the AP 102-a (e.g., the AP MLD).

The AP 102-a (e.g., the AP MLD) may transmit a frame 502 via a first frequency band associated with omni-directional communications. The frame 502 may include information (e.g., timing information 510) for a second frequency band associated with directional communications. The STA 104-a (e.g., the non-AP MLD) may receive the frame 502 with the timing information 510. The information may indicate a time at which the AP 102-a is scheduled to transmit a set of messages (e.g., a set of ASR messages 506) via the second frequency band.

In some examples, the frame 502 may advertise basic 60 GHz information via a sub7 link. The frame 502 may indicate an identity of the AP 102-a, the timing information 510 for ASR message transmission by the AP 102-a, or both. In some implementations, the frame 502 may indicate a BSSID (e.g., spanning 6 octets or 48 bits), such as MAC address, that indicates the identity of the AP 102-a. Additionally, or alternatively, the frame 502 may indicate a beacon interval (BI) (e.g., spanning 2 octets or 16 bits), a timing synchronization function (TSF) offset value (e.g., spanning 8 octets or 64 bits), a transmission period periodicity (e.g., an ATP periodicity, which may span 4 bits), a quantity of sectors (e.g., spanning 1 octet or 8 bits to signal up to 255 sectors), a dwell time per sector (e.g., spanning 4 bits to support up to 16 microseconds (μs)), a next ATP TSF (e.g., spanning 2 octets or 16 bits to signal the lower 2 octets of the 60 GHz TSF), or any combination thereof. The timing information 510 may include any combination of the BI, the TSF offset, the ATP periodicity, the quantity of sectors, the dwell time per sector, the next ATP TSF, or any other timing value. The ATP periodicity (or schedule) may be indicated as a multiple of the BI (e.g., each BI may include an ATP, or a fraction of the BIs may include an ATP). For example, a 4-bit ATP periodicity field may support from every BI including an ATP up to every 16th BI including an ATP. The next ATP TSF may indicate a start time (e.g., a TSF value) for a subsequent ATP window.

In some examples, the timing information 510 may include TSF information of the directional link (e.g., the 60 GHz link). For example, the MLO framework may enable signaling via the omni-directional link to provide a TSF offset of the directional link affiliated with the same AP MLD (e.g., the AP 102-a). If both the omni-directional link and the directional link share the same clock (e.g., use the same TSF clock), the TSF offset value may be 0. However, if the links use different clocks, the TSF offset value may be different from (e.g., greater than) 0. The TSF offset value may be a constant value with a drift within a defined threshold (e.g., a drift of no more than 30 μs).In some examples, the frame 502 may include a basic ML information element (IE) that includes a per-STA profile (e.g., within a STA information field). If the per-STA profile includes complete information for a reported affiliated AP (e.g., a 60 GHz AP), the per-STA profile may include the TSF offset value for the AP within a TSF offset subfield. The TSF offset subfield may indicate the TSF offset, T_{offset}, between the TSF timer, T_{A}, of the reported AP (e.g., the 60 GHz AP of the AP MLD) and the TSF timer, T_{B}, of the reporting AP (e.g., the sub7 AP of the AP MLD). That is, the TSF offset value may indicate a difference between the TSF clock for a 60 GHz link (e.g., the directional link) and the TSF clock for a sub7 link (e.g., the omni-directional link). In some examples, the TSF offset value may be encoded as a 2s complement signed integer with units of 2 μs and may be calculated according to Equation 1.

T_{offset}=└(T_{A}-T_{B})/2┘ (1)

Accordingly, the non-AP MLD receiving the per-STA profile via the omni-directional link may receive the TSF offset value for the directional link associated with the same AP MLD. The non-AP MLD may use the TSF offset value to accurately and reliability determine timing for one or more operations via the directional link (e.g., such as timing for beam training operations).

In some implementations, clock drift may occur between TSF timers for different links. The MLDs may maintain synchronization and correct clock drift for affiliated APs (e.g., the sub 7 AP and the 60 GHz AP) to comply with a threshold for clock drift. That is, each pair of affiliated APs (e.g., each link of an ML setup) may comply with Equation 2.

|(T1_{AP1}−T2_{AP1})−(T1_{AP2}−T2_{AP2})|≤Threshold Drift (2)

AP1 and AP2 may be any two affiliated APs of the same AP MLD (e.g., the AP 102-a), and T1 and T2 may be the TSFs of the respective APs at any two instances in time. In some examples, the Threshold Drift value may be 30 μs. However, in some other examples, the Threshold Drift value may be relatively smaller than 30 μs (e.g., 5 μs, 10 μs) to support accurate coordination between the omni-directional link and the direction link.

The AP 102-a (e.g., the AP MLD) may transmit multiple messages (e.g., multiple ASR messages 506) based on the information (e.g., the timing information 510). For example, the timing information 510 may indicate the time (e.g., a start time, a time window, a partial or full TSF value, an identifier for an O-SP, an identifier for a D-SP, an identifier for an ATP) at which the AP 102-a transmits the ASR messages 506 via the second frequency band (e.g., via the 60 GHz band or a 60 GHz link). In some examples, the AP 102-a may transmit the ASR messages 506 during an ATP, during a service period, or during some other time window. Each ASR message 506 of the set of ASR messages 506 may correspond to a respective beam direction (e.g., corresponding to a respective sector covered by the AP 102-a). For example, a first ASR message 506-a may correspond to a first sector 504-a, a second ASR message 506-b may correspond to a second sector 504-b, a third ASR message 506-c may correspond to a third sector 504-c, and a fourth ASR message 506-d may correspond to a fourth sector 504-d. In some implementations, the AP 102-a may transmit the ASR messages 506 in a sector sweep that covers a full 360-degree sweep for the AP 102-a. In some other implementations, the AP 102-a may perform a partial sector sweep (e.g., transmitting ASR messages 506 corresponding to a subset of sectors supported by the AP 102-a).

The STA 104-a (e.g., the non-AP MLD) may monitor the second frequency band for one or more of the ASR messages 506 based on the timing information 510. For example, the STA 104-a may monitor at the indicated time (e.g., starting at the indicated start time, during the indicated time window) for the ASR messages 506. In some implementations, multiple STAs 104 (not shown) may monitor for the ASR messages 506 during the same time window. For example, the time window for the ASR messages 506 (e.g., the ATP, the service period) may be common across non-AP MLDs.

In some examples, an ASR message 506 may be referred to as an ASR frame, an ASR packet, a sweep packet, an AP sweep packet, or any other similar terminology. The ASR message 506 may indicate a sector identifier (ID) (e.g., spanning 1 octet or 8 bits), an AP transmit power (e.g., spanning 1 octet or 8 bits), a BSS color or other AP identifier (e.g., spanning 6 bits), a partial or full TSF value (e.g., spanning 2 octets or 16 bits), or any combination of this or other information. The AP 102-a may use relatively small frames for the ASR messages 506 to reduce a signaling overhead associated with the sector sweep. The ASR messages 506 may operate as references for non-AP MLDs (e.g., the STA 104-a) to determine reachability, determine ML associations, perform beam training decisions, or any combination thereof.

In some examples, the STA 104-a may use an ASR message 506 to determine reachability for the second frequency band (e.g., the directional frequency band, such as the 60 GHz band). For example, if the STA 104-a is unassociated with the AP 102-a, the STA 104-a may determine whether to establish an ML association with the AP 102-a via a link 508 based on the reachability. Alternatively, if the STA 104-a is associated with the AP 102-a, but the ML association does not include a link 508 via the second frequency band, the STA 104-a may determine whether to add or delete the link 508 based on the reachability.

To determine reachability, the STA 104-a may tune to (e.g., monitor) the second frequency band during the indicated time window (e.g., ATP or service period). If the STA 104-a fails to detect any ASR message 506 during the time window, the STA 104-a may determine that it is outside the range (e.g., the reach) of the AP 102-a via the second frequency band. Alternatively, if the STA 104-a detects (e.g., receives) at least one ASR message 506, the STA 104-a may determine a reachability measurement of the AP 102-a. For example, the ASR message 506 may indicate a transmit power used by the AP 102-a to transmit the ASR message 506, and the STA 104-a may measure a receive power for reception of the ASR message 506 at the STA 104-a. Using the transmit power and the receive power, the STA 104-a may calculate (e.g., determine, or otherwise ascertain) a path loss measurement for the ASR message 506 between the AP 102-a and the STA 104-a. Based on the path loss measurement, the STA 104-a may determine whether it is within range (e.g., within reach) of the AP 102-a via the second frequency band. For example, if the path loss measurement satisfies (e.g., is less than) a threshold value, the receive power satisfies (e.g., is greater than) a threshold value, or both, the STA 104-a may determine that the reach of the AP 102-a supports the STA 104-a and the AP 102-a establishing a link 508 via the second frequency band. As used herein, “satisfying a threshold” or “satisfying a threshold value” may, depending on the context, refer to a value being greater than the threshold, greater than or equal to the threshold, less than the threshold, less than or equal to the threshold, equal to the threshold, not equal to the threshold, or the like. Similarly, “failing to satisfy a threshold” or “failing to satisfy a threshold value” may, depending on the context, refer to a value being greater than the threshold, greater than or equal to the threshold, less than the threshold, less than or equal to the threshold, equal to the threshold, not equal to the threshold, or the like.

In some examples, the AP's reach via the second frequency band may be different than the STA's reach via the second frequency band. For example, the STA 104-a may support a relatively lower transmit power than the AP 102-a. As such, the STA 104-a may determine reachability based on the determined path loss measurement and the STA's supported transmit power (e.g., to determine whether the STA 104-a support transmitting signals to the AP 102-a via the second frequency band). For example, the STA 104-a may determine 60 GHz reachability for the AP 102-a, 60 GHz reachability of the STA 104-a, or both based on receiving one or more ASR messages 506.

Additionally, or alternatively, the STA 104-a may use one or more received ASR messages 506 for beam training. For example, a relatively recently associated STA 104-a (e.g., associated via the second frequency band for directional communications) may use the ASR messages 506 to perform initial beam training. Additionally, or alternatively, an associated STA 104-a may use the ASR messages 506 to determine whether to perform additional beam training (e.g., updating beams, beam refinement). For example, the STA 104-a may initiate beam training during a D-SP if an ASR message 506 is not receive or is received but fails to satisfy a threshold receive power.

A relatively newly associated STA 104-a may request, via the first frequency band, to perform beam training for the second frequency band. Similarly, a STA 104-a that transitions from a doze state to an awake state on the second frequency band may request to perform beam retraining. The request may be an example of a request frame transmitted by the STA 104-a (e.g., a non-AP MLD) to the AP 102-a (e.g., the AP MLD). The request frame may indicate whether the AP 102-a is to perform an AP sector sweep to support the beam training. For example, if the AP 102-a relatively recently performed an AP sector sweep, and the STA 104-a monitored for the ASR messages 506, the STA 104-a may use the measurements from this recent AP sector sweep for beaming training, and the AP 102-a may skip an additional AP sector sweep for the beam training. Alternatively, if a next AP sector sweep is relatively far away (e.g., multiple BIs away), the STA 104-a may request the beam training to include an AP sector sweep.

The AP 102-a may receive the request frame and may transmit, in response, a response frame that indicates whether the AP 102-a accepts the request via the first frequency band. In some examples, the AP 102-a may allocate a next available O-SP to handle the request for beam training. For example, the AP 102-a may transmit, in response to the request frame, a response frame (e.g., via the first frequency band) that indicates an O-SP (or other service period or time) to perform the beam training. Alternatively, if the AP 102-a advertises an O-SP as a broadcast TWT via the first frequency band, the response frame may indicate the broadcast TWT ID for the O-SP (e.g., for the second frequency band). Additionally, or alternatively, the response frame may include TSF information for the second frequency band (e.g., timing information 510, such as a partial or full TSF value). Such a TSF indication may support a TSF accuracy greater than 30 μs (e.g., less than 10 μs). The TSF information may be indicated with reference to an event (e.g., the start of an ATP or other event time).

The STA 104-a may receive the response frame and may wake up at the start of the indicated O-SP to monitor the second frequency band. If the STA 104-a requested an AP sector sweep (or, in some examples, as a default mechanism), the AP 102-a may perform an AP sector sweep (e.g., transmitting the ASR messages 506) and the STA 104-a may perform a packet sweep to support the beam training. If the STA 104-a refrained from requesting the AP sector sweep or requested skipping the AP sector sweep, the STA 104-a may perform the packet sweep to support the beam training. The STA 104-a, the AP 102-a, or both may provide beam training feedback (e.g., indicating selected beams, received packets or frames) via the first frequency band (e.g., the sub7 link).

In some systems, similar to the STA 104-a, the AP 102-a may trigger beam training for the second frequency band (e.g., the 60 GHz frequency band). For example, the AP 102-a may transmit a request frame that indicates an O-SP or other time window to perform the beam training. The STA 104-a may receive the request frame and may transmit, in response, a response frame that indicates whether the STA 104-a accepts the request (e.g., is willing to participate in the beam training) via the first frequency band. The request frame, the response frame, or both may indicate whether to perform the AP sector sweep in the indicated O-SP.

In some examples, the request frame may be an example of an action frame that requests training or retraining. This action frame may be a new (protected) action frame. The action frame may support a flexible structure to include parameters relating to initiating beam training. In some examples, specific fields may be present depending on the wireless device transmitting the action frame. For example, if the AP 102-a transmits the action frame (e.g., the request frame), the action frame may include an indication of a service period (e.g., an O-SP) or other timing indicator (e.g., TSF value or window) in which to perform the beam training. If the STA 104-a transmits the action frame, this field may not be present. Additionally, or alternatively, the response frame may be an example of the same action frame or a different action frame. This action frame may indicate a device's availability, acceptance, or acknowledgment to perform the requested beam training. If the AP 102-a transmits the action frame (e.g., the response frame), the action frame may include the indication of the service period or other timing indicator in which to perform the beam training. In some examples, the AP 102-a may indicate different service periods for the AP sector sweep (e.g., an O-SP or other time period) and for the non-AP packet sweep (e.g., a D-SP or other time period). If the STA 104-a transmits the action frame (e.g., the response frame), the action frame may indicate whether an AP transmit sweep is requested. If the same action frame format supports both the request and response frames, the action frame may include a field that indicates whether the frame is a request (e.g., a notification) or a response (e.g., a confirmation). Other contents of the action frame may depend on the value of this field (e.g., whether the frame is a request or a response frame).

If beam training is accepted, the AP 102-a and the STA 104-a may perform the beam training using the ASR messages 506, sweep packets transmitted by the STA 104-a, or both. The AP 102-a and the STA 104-a may select communication beams to use for directional communications via the second frequency band (e.g., the 60 GHz frequency band). The AP 102-a and the STA 104-a may add or establish a link 508 corresponding to the second frequency band based on the selected communication beams. A communication beam may be an example of an AP beam, a STA beam, a transmit beam, a receive beam, an uplink beam, a downlink beam, or any combination thereof.

In some examples, the STA 104-a may include multiple radios or multiple radio configurations. For example, the STA 104-a may include a full-power radio (e.g., a main radio, default radio, or full-capability radio) and a low-power radio (e.g., an auxiliary radio, secondary radio, or reduced-capability radio that uses relatively less power than the full-power radio). Additionally, or alternatively, the STA 104-a may include a radio that can operate according to different power levels, such as a full-power mode or a low-power mode. In some implementations, the STA 104-a may use the low-power radio (or low-power radio mode) to monitor the second frequency band (e.g., the 60 GHz frequency band) for signaling from the AP 102-a, such as one or more ASR messages 506. In some examples, the low-power radio may support signal detection, signal reception, or both, but the low-power radio may refrain from supporting signal transmission. The STA 104-a may receive at least one ASR message 506 using the low-power radio and may determine reachability, perform beam training (e.g., beam retraining or beam refinement), or both based on the at least one ASR message 506. If the STA 104-a establishes a link 508 with the AP 102-a via the second frequency band (e.g., the 60 GHz frequency band), the STA 104-a may communicate via the link 508 using the full-power radio (e.g., for transmission, reception, or both). The STA 104-a may reduce a processing overhead and save battery power based on using the low-power radio to monitor the second frequency band (e.g., periodically, according to a schedule), and the STA 104-a may support high throughput signaling via the second frequency band based on using the full-power radio for communications via the second frequency band.

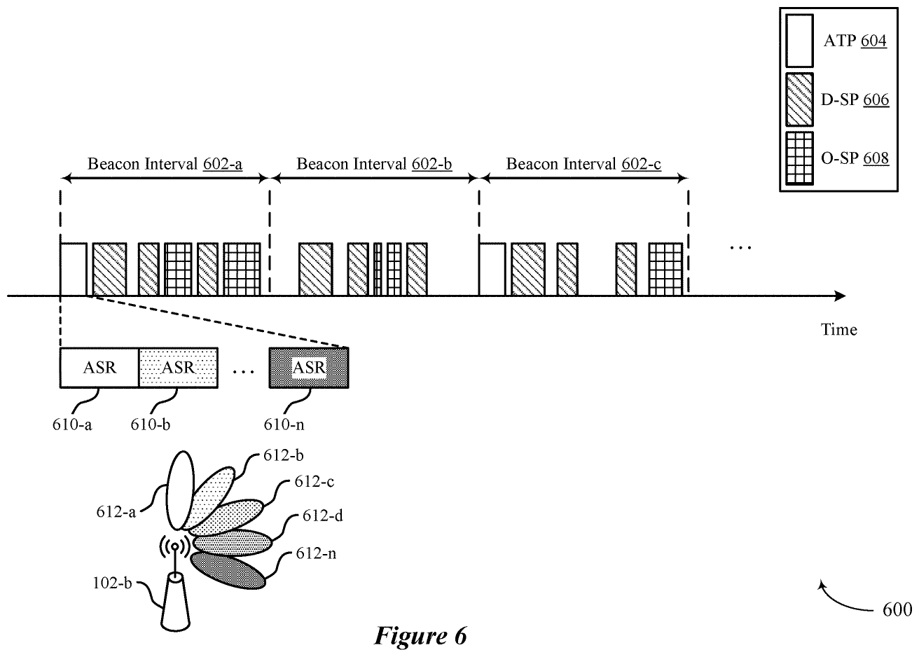

FIG. 6 shows an example of a timeline 600 that supports ML aided beam training for IMMW operation. The timeline 600 may include a configuration of time windows for a frequency band, such as the second frequency band described with reference to FIG. 5. For example, the timeline 600 may indicate a division of the medium time for the 60 GHz frequency band (or a similar frequency band) that supports directional communications.

The medium time on the 60 GHz frequency band may be logically divided into a series of repeating segments referred to as beacon intervals (BIs). For example, the timeline 600 may include a first BI 602-a, a second BI 602-b, and a third BI 602-c. A BI may include one or more ATPs 604, one or more service periods, or both. In some examples, a BI may include an ATP 604 in an initial portion of the BI, followed by one or more D-SPs 606, one or more O-SPs 608, or both. In some implementations, the ATP 604 may be absent from some BIs. For example, the ATP 604 may be present in BIs in accordance with an ATP periodicity, such as every other BI or some other portion of scheduling of ATPs within select BIs. During the ATP 604 for an AP MLD (e.g., an AP 102-b, which may be an example of an AP 102 as described with reference to FIGS. 1 and 5), the AP MLD may transmit multiple messages (e.g., multiple ASR messages) in a sector sweep for the 60 GHz frequency band. For example, the AP MLD (e.g., the AP 102-b) may transmit a first ASR message 610-a via a first communication beam 612-a (e.g., an AP beam, a downlink transmit beam), a second ASR message 610-b via a second communication beam 612-b, up to an n^{th} ASR message 610-n via a n^{th} communication beam 612-n. The AP 102-b may transmit the ASR messages at different times, different frequencies, or both. In some examples, the AP 102-b may repeat a transmission of one or more ASR messages within the ATP 604 (e.g., based on detected interference, to improve a probability of reception). A STA 104 (e.g., a non-AP MLD) may monitor for the ASR messages during at least a portion of the ATP 604. Depending on the location of the STA 104, the STA 104 may receive one ASR message, no ASR messages, or multiple ASR messages based on monitoring the second frequency band during the ATP 604. For example, the STA 104 may receive ASR messages corresponding to a third communication beam 612-c and a fourth communication beam 612-d. The STA 104 may use the received ASR messages to determine reachability of the AP 102-b via the 60 GHz frequency band, perform beam training, or both.

The service periods may support frame exchanges between wireless devices (e.g., between MLDs) via the 60 GHz frequency band. In some examples, a D-SP 606 may be dedicated (e.g., scheduled) for communications between wireless devices, such as between an AP 102 and a STA 104). An O-SP 608 may be dynamically configured on-demand for communications between wireless devices, such as between the AP 102 and the STA 104. Different combinations of devices may use different service periods within the 60 GHz medium for communications. In some examples, the AP 102-b may indicate that an ASR frame sector sweep may occur during a service period (e.g., a D-SP 606 or an O-SP 608). In some such examples, a non-AP MLD (e.g., a STA 104) may monitor for ASR frames during at least a portion of the service period.

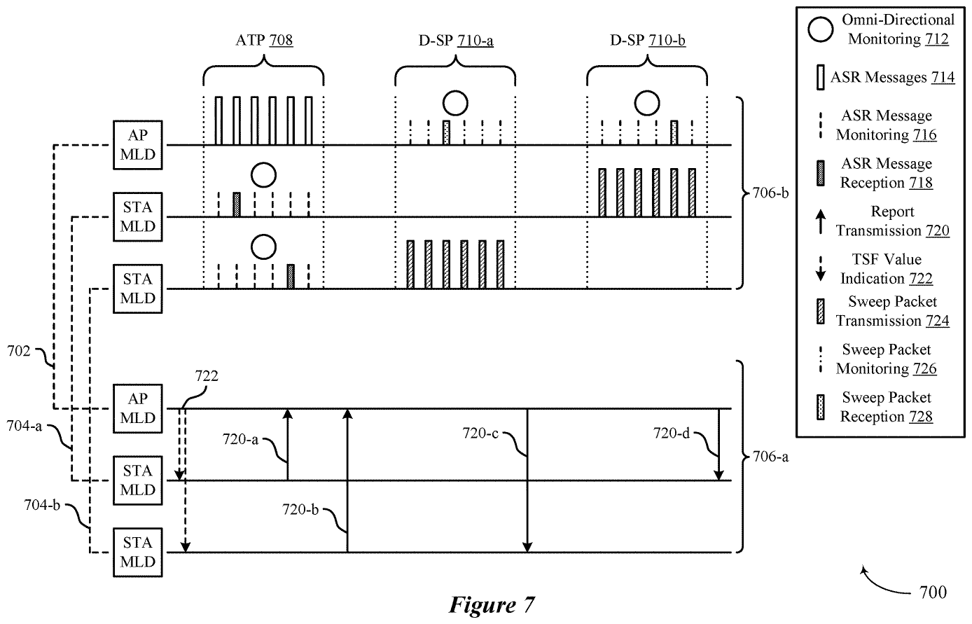

FIG. 7 shows an example of a signaling timeline 700 that supports ML aided beam training for IMMW operation. The signaling timeline 700 may involve an AP MLD 702, a first non-AP MLD 704-a (such as a first STA MLD), and a second non-AP MLD 704-b (such as a second STA MLD). The AP MLD 702 may support a first link via a first frequency band 706-a and a second link via a second frequency band 706-b. For example, the first AP link may be an example of a sub7 link and the second AP link may be an example of a 60 GHz link. Similarly, the first non-AP MLD 704-a may support a first link via the first frequency band 706-a and a second link via the second frequency band 706-b, and the second non-AP MLD 704-b may support a first link via the first frequency band 706-a and a second link via the second frequency band 706-b. The MLDs may leverage MLO to improve the overhead and latency associated with discovery, reachability, ML association, link setup, beam sweeping procedures, or any combination thereof for the second frequency band 706-b (such as the 60 GHz frequency band supporting directional communications).

The MLDs may operate in a non-standalone (NSA) mode, such that an MLD may pair a 60 GHz link with a partner link via the sub 7 frequency band 706-a. Using an MLO framework, an MLD may perform management-level signaling for the 60 GHz link via one or more sub7 links. For example, the MLDs may perform discovery, multi-link setup, other agreements (such as BA and timing coordination agreements), or any combination thereof via the sub7 link. The non-AP MLDs may determine (such as receive, select, or otherwise ascertain) information relating to a 60 GHz link, include the 60 GHz link as part of a multi-link set, set up service periods for the 60 GHz link, or any combination thereof using communications via the sub7 link, for example, without exchanging frames via the 60 GHz link. As such, the MLDs may use omni- or quasi omni-directional (such as non-directional) communications via the sub7 link to support beamforming operations for the partnered 60 GHz link. Although described herein with reference to a sub 7 link and a 60 GHz link, the techniques described herein may apply to other types of links associated with other frequency bands. For example, although some aspects described herein use a sub-7 GHz and a 60 GHz frequency band as examples for the first frequency band and the second frequency band respectively, other appropriate frequency bands may additionally, or alternatively, be used for the first frequency band (e.g. a relatively lower frequency band supporting omni- or quasi omni-directional signaling) and the second frequency band (e.g. a relatively higher frequency band support directional signaling, such as, a 45 GHz frequency band, or a 28 GHz frequency band).

In some examples, an unassociated non-AP MLD, such as the non-AP MLD 704-a, may perform ML probing via the sub7 frequency band 706-a. In some implementations, the non-AP MLD 704-a may perform reachability measurements for the sub7 frequency band 706-a to determine whether an AP MLD 702 supports a sub7 link with the non-AP MLD 704-a. If the non-AP MLD 704-a determines that the reachability on the sub7 frequency band 706-a supports the non-AP MLD 704-a (e.g., for both reception from the AP MLD 702 and transmission to the AP MLD 702), the non-AP MLD 704-a may determine information (e.g., timing information) for an AP sector sweep.

In some other examples, a non-AP MLD, such as the non-AP MLD 704-a, may be associated with the AP MLD 702 via the sub7 frequency band 706-a but not via the 60 GHz frequency band 706-b. For example, the ML association or ML setup between the non-AP MLD 704-a and the AP MLD 702 may not include a 60 GHz link. The non-AP MLD 704-a may determine whether a 60 GHz link is reachable (e.g., by performing reachability measurements) to determine whether to add the 60 GHz link to the existing ML association or ML setup between the MLDs.

The multi-link operation framework may involve the AP MLD 702 maintaining constant TSF offsets for each link (such as each affiliated AP) associated with the AP MLD 702. In some implementations, the AP MLD 702 may advertise one or more TSF offsets, where a TSF offset is for a first AP link with respect to another affiliated AP link. For example, the AP MLD 702 may transmit a frame, such as an advertisement packet or another packet, including a TSF value indication 722 associated with a link of the AP MLD 702, such as a second link associated with the 60 GHz frequency band 706-b. In some implementations, the frame may be an example of a beacon frame transmitted (e.g., broadcasted or multicasted) by the AP MLD 702 (e.g., to one or more non-AP MLDs). In some other implementations, a non-AP MLD, such as the non-AP MLD 704-a, may request the frame by transmitting an ML probe request frame. For example, the non-AP MLD 704-a may be unassociated with the AP MLD 702 and may transmit the ML probe request frame requesting information about multiple links supported by the AP MLD 702. The AP MLD 702 may receive the ML probe request frame and may transmit, in response, an ML probe response frame that includes information about one or more links supported for MLO. The ML probe response frame may include the TSF value indication 722. The frame may include a TSF offset field or subfield indicating an offset between a TSF timer of a first AP of the AP MLD 702 and a TSF timer of a second AP of the AP MLD 702, where the offset may be an example of a TSF value indication 722. The AP MLD 702 may transmit the TSF value indication 722 via the first link using an omni- or quasi omni-directional transmission. One or more non-AP MLDs, such as the non-AP MLD 704-a, may receive the packet and may determine (such as receive, decode, process, or otherwise ascertain) the TSF for at least one link of the AP MLD 702. Using the constant TSF offset information, the non-AP MLD 704-a may use the received TSF value for any one link of the AP MLD 702 to determine (such as calculate, select, or otherwise ascertain) the TSF for any other link of the AP MLD 702 in accordance with a TSF offset.

The AP MLD 702 may negotiate or indicate information (e.g., timing information) with the non-AP MLD 704-a via the sub7 link to support beam training procedures for the 60 GHz link. For example, the AP MLD 702 may indicate to the non-AP MLD 704-a an exact time, such as an exact TSF value, for beam training. This time can be common to more than one non-AP MLD or can be reserved for a specific non-AP MLD. For example, a common start time for multiple non-AP MLDs to perform beam training may be an example of a start time for a transmission period (e.g., an ATP). During the ATP, the AP MLD 702 may perform a common beam sweep for multiple non-AP MLDs. The AP MLD 702 may configure a start time for a beam sweeping procedure via the 60 GHz frequency band, a dedicated time period for beam training, or both using the TSF information. For example, the AP MLD 702 and the non-AP MLD 704-a may establish a devoted service period for performing beam sweeping. In some systems, the dedicated time periods may be set up to repeat at relatively frequent intervals (for a relatively long period of time) such that the dedicated periods may be used for exchanging data frames between the AP MLD 702 and the non-AP MLD 704-a after the beam training procedure commences (and directional beams between the AP MLD 702 and the non-AP MLD 704-a have been established). The relatively highly directional nature of the 60 GHz frequency band may support the MLDs gaining access to the 60 GHz medium for the devoted service period to perform directional transmissions.

The AP MLD 702 may transmit, via the second link, a set of messages (e.g., a set of ASR messages 714) during the configured time period, and the non-AP MLD 704-a may perform omni- or quasi omni-directional monitoring 712 during the configured time period. For example, the non-AP MLD 704-a may monitor the second frequency band 706-b for the ASR messages 714 during the configured time period in accordance with the indicated TSF value and the fixed pattern for the sweep packets. The non-AP MLD 704-a may detect, or otherwise receive, one or more of the ASR messages 714 in accordance with the ASR message monitoring 716. If the non-AP MLD 704-a receives one ASR message 714, the non-AP MLD 704-a may determine (such as receive, decode, process, or otherwise ascertain) the corresponding sector of the ASR message reception 718. If the non-AP MLD 704-a receives more than one ASR message 714, the non-AP MLD 704-a may determine (such as calculate, select, or otherwise ascertain) the sector for the ASR message reception 718 that satisfies a threshold, such as a signal strength or signal quality threshold. The non-AP MLD 704-a may transmit a report 720-a via the first link indicating the determined sector or another value that corresponds to the determined sector (e.g., a TSF value, a message ID, a packet ID, a beam ID). The non-AP MLD 704-a may receive the report 720-a and may select a transmit beam to use for the second link that corresponds to the reported value, such as the reported TSF value and/or a reported sector. Additionally, or alternatively, the non-AP MLD 704-a may perform similar beam training to select a transmit beam to use for the second link.

In some implementations, a non-AP MLD 704-a may trigger communication beam training for a 60 GHz link in accordance with one or more factors. If the non-AP MLD 704-a newly associates with the AP MLD 702 for a 60 GHz link, the non-AP MLD 704-a may perform beam training (e.g., initial beam training) with the affiliated AP for the 60 GHz band prior to initiating frame exchanges via the 60 GHz link. The non-AP MLD 704-a may perform discovery, multi-link setup, or both via the sub7 frequency band using the MLO framework. Additionally, or alternatively, if a non-AP MLD 704-a is inactive for at least a threshold amount of time via the 60 GHz link, the non-AP MLD 704-a may perform beam training with the affiliated AP for the 60 GHz band to update beam selection if the orientation of the non-AP MLD 704-a to the AP MLD 702 has changed during the period of inactivity. Additionally, or alternatively, a non-AP MLD 704-a that is active via the 60 GHz link may trigger beam training if the non-AP MLD 704-a detects beam misalignment with the AP MLD 702. In some implementations, the affiliated AP for the 60 GHz band may transmit a reference signal or another packet via the 60 GHz link that indicates to the non-AP MLD 704-a whether any beam misalignment has occurred. In some other implementations, the AP MLD 702 may determine (such as identify, calculate, or otherwise detect) beam misalignment with the non-AP MLD 704-a and may transmit, to the non-AP MLD 704-a, an indication to trigger beam training. The non-AP MLD 704-a may perform beam training or refinement if beam misalignment is detected.

In some implementations, the AP MLD 702 may perform a beam sweep procedure (e.g., an AP sector sweep) for the 60 GHz frequency band during one or more common periods. For example, the affiliated AP for the 60 GHz band may perform a transmit beam sweep during the one or more common periods. The AP MLD 702 may advertise information about the one or more common periods via the sub7 link. One or more non-AP MLDs may monitor the 60 GHz band during the common period to derive relevant beam training information. For example, during a same common period, an active non-AP MLD 704-a may determine (such as identify or select) to retrain or refine beam alignment, while a newly associated or newly active non-AP MLD 704-b may perform beam training using the same ASR messages 714, effectively aggregating the AP MLD's transmit sweep for multiple non-AP MLDs. Accordingly, any quantity of non-AP MLDs may monitor the second frequency band 706-b during the common period and may receive the same or different ASR messages 714 in accordance with the monitoring. In some implementations, the common period may be referred to as a transmit period, an ATP, or any similar terminology. The ATP 708 duration may be relatively short. Both the first non-AP MLD 704-a and the second non-AP MLD 704-b may perform omni- or quasi omni-directional monitoring 712 during the ATP 708 and may receive different ASR messages 714 during the ATP 708 in accordance with the different directions between the AP MLD 702 and the different non-AP MLDs. An ASR message 714 or “ASR frame” may be an example of, or similar to, a relatively short beacon or beacon frame. The first non-AP MLD 704-a may transmit a first report 720-a indicating a first ASR message reception 718 at the first non-AP MLD 704-a, and the second non-AP MLD 704-b may transmit a second report 720-b indicating a second ASR message reception 718 at the second non-AP MLD 704-b.

In some implementations, the AP MLD 702 may split its transmit beam sweep across multiple ATPs 708. For example, the AP MLD 702 may perform a partial beam sweep during an ATP 708. In some implementations, the AP MLD 702 may transmit ASR messages associated with respective transmit beams corresponding to a first subset of sectors of the AP MLD 702 during the ATP 708, and the AP MLD 702 may transmit ASR messages associated with respective transmit beams corresponding to a second subset of sectors of the AP MLD 702 different from the first subset of sectors during a subsequent ATP 708. If the beam sweep during an ATP 708 does not cover the sector corresponding to a non-AP MLD, the non-AP MLD may fail to detect an ASR message 714 from the AP MLD 702 during the ATP 708. The non-AP MLD may refrain from reporting an ASR message reception 718 if the non-AP MLD fails to detect a sweep packet while monitoring during the ATP 708. For example, if the non-AP MLD supports trigger-based (TB) reporting, the non-AP MLD may respond to a trigger frame (TF) with a null, or otherwise empty (such as a 0 value), report.

The non-AP MLD 704-a may perform ML setup with the AP MLD 702 if a set of criteria or thresholds is satisfied. For example, the set of criteria may include 60 GHz capabilities for the non-AP MLD 704-a, the AP MLD 702, or both; reachability between the non-AP MLD 704-a and the AP MLD 702; or both.

In some implementations, the AP MLD 702 may configure devoted, or dedicated, time periods for the non-AP MLDs to perform transmit beam sweeps. For example, the AP MLD 702 may establish a first dedicated time period for the first non-AP MLD 704-a to perform a transmit beam sweep via the 60 GHz frequency band and may establish a second dedicated time period for the second non-AP MLD 704-b to perform a transmit beam sweep via the 60 GHz frequency band. The devoted, or dedicated, time period may be referred to as a devoted service period, a devoted sweep period, or other similar terminology. The D-SP duration may span several milliseconds. In some implementations, the AP MLD 702 may set up a D-SP for the non-AP MLD 704-a via sub7 signaling, for example, using an AP coordination interval framework (such as a cross-link TWT setup). For example, the AP MLD 702 may configure, via one or more sub7 links, a first D-SP 710-a for the non-AP MLD 704-b and a second D-SP 710-b for the non-AP MLD 704-a. In some implementations, a non-AP MLD may use a configured D-SP for data exchange via the 60 GHz band after completion of the beam training procedures for the 60 GHz band.

During the first D-SP 710-a, the non-AP MLD 704-b may perform sectorized sweep packet transmissions 724 via the 60 GHz band, and the AP MLD 702 may perform sweep packet monitoring 726 for the 60 GHz band to detect the sweep packet transmissions 724. The AP MLD 702 may use omni- or quasi omni-directional monitoring or may monitor according to a direction selected for a transmit beam in accordance with the AP MLD's transmit beam sweep. If the AP MLD 702 detects, or otherwise receives, one or more sweep packet transmissions 724 from the non-AP MLD 704-b, the AP MLD 702 may transmit a report 720-c indicating the sweep packet reception 728. The AP MLD 702 may transmit the report 720-c to the non-AP MLD 704-b via the sub7 link.

Additionally, or alternatively, during the second D-SP 710-b, the non-AP MLD 704-a may perform sectorized sweep packet transmissions 724 via the 60 GHz band, and the AP MLD 702 may monitor the 60 GHz band for the sweep packet transmissions 724. If the AP MLD 702 detects, or otherwise receives, one or more sweep packet transmissions 724 from the non-AP MLD 704-a, the AP MLD 702 may transmit a report 720-d indicating the sweep packet reception 728. The AP MLD 702 may transmit the report 720-d to the non-AP MLD 704-a via the sub7 link.

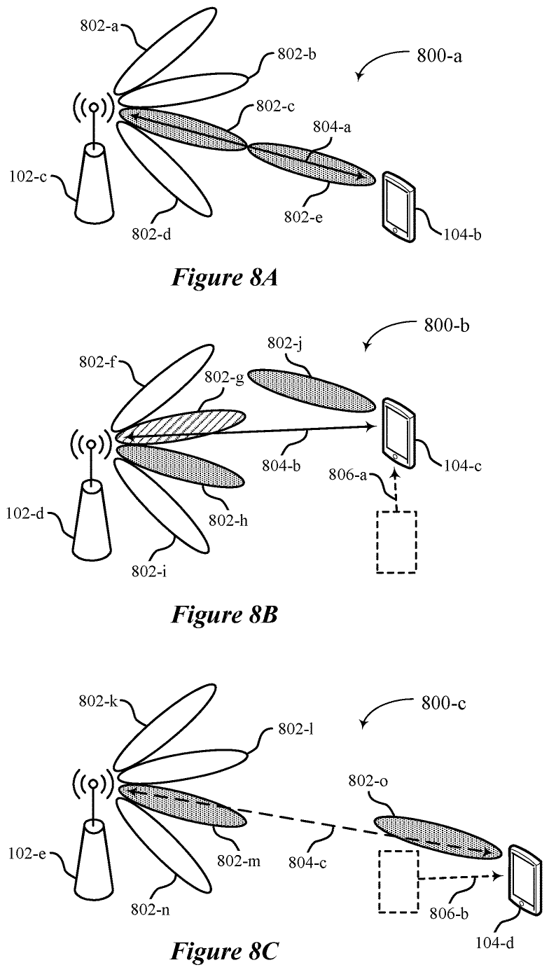

FIGS. 8A, 8B, and 8C show examples of handling wireless STA mobility that support ML aided beam training for IMMW operation. FIG. 8A shows an example of handling wireless STA mobility 800-a that supports ML aided beam training for IMMW operation. An AP MLD may associate with a non-AP MLD via a frequency band that supports directional communications, such as the 60 GHz frequency band. For example, an AP 102-c, which may be an example of an AP 102 described with reference to FIGS. 1 and 5-7, may communicate with a STA 104-b, which may be an example of a STA 104 described with reference to FIGS. 1 and 5-7, via a directional link 804-a (e.g., corresponding to the 60 GHz frequency band).

The AP 102-c and the STA 104-b may perform one or more communication beam training procedures to select (e.g., determine, identify, or otherwise ascertain) communication beams for wireless directional communication between the AP 102-c and the STA 104-b. For example, the AP 102-c may perform an AP sector sweep, transmitting messages (e.g., ASR messages) via a first communication beam 802-a, a second communication beam 802-b, a third communication beam 802-c, and a fourth communication beam 802-d. The STA 104-b may receive ASR frames via the second communication beam 802-b, the third communication beam 802-c, and the fourth communication beam 802-d. In some examples, the STA 104-b may measure receive power metrics for the detected (e.g., received) ASR frames. The receive power metric may be a received signal strength indicator (RSSI) value or another indicator of the signal strength or signal quality of the ASR frame. In some examples, the STA 104-b may store the receive power metrics corresponding to the different ASR frames (e.g., the different AP sectors, the different communication beams) for a first time period (e.g., a first ATP).

In some implementations, the STA 104-b may determine that the ASR frame received via the third communication beam 802-c is received with a greatest receive power (e.g., as compared to the other received ASR frames). In some examples, the STA 104-b may select a communication beam 802-e based on the corresponding third communication beam 802-c. In some other examples, the STA 104-b may additionally perform a packet sweep to select the communication beam 802-e. The AP 102-c may select the third communication beam 802-c based on receiving a report from the STA 104-b indicating reception of the ASR frame via the third communication beam 802-c with the relatively highest receive power (e.g., RSSI value).

FIG. 8B shows an example of handling wireless STA mobility 800-b that supports ML aided beam training for IMMW operation. The STA 104-c may be an example of the STA 104-b after moving locations 806-a. The AP 102-d may be an example of the AP 102-c. The AP 102-d and the STA 104-c may communicate via a directional link 804-b (e.g., corresponding to the 60 GHz frequency band). The STA 104-c (e.g., a 60 GHz non-AP STA) may monitor one or more ATPs, or other time windows supporting AP sector sweeps, to measure receive power metrics (e.g., RSSI values) for the ASR frames. During an initial beam training procedure, or after waking from a deep sleep mode (e.g., a low power mode), the STA 104-c may use the receive power metrics to determine (e.g., select, identify) a strongest sector for beam-based communications. For subsequent scans (e.g., subsequent monitoring for the ASR frames), the STA 104-c may determine whether its beam orientation with respect to the AP 102-d has changed, whether it has moved away from the AP 102-d, or both.

For example, the STA 104-c may remeasure receive power metrics for ASR frames after moving locations 806-a. The STA 104-c may communicate via a communication beam 802-j at the STA 104-c and a communication beam 802-h at the AP 102-d for the directional link 804-b. After moving locations 806-a, the STA 104-c may monitor for the ASR frames and may receive ASR frames via a first communication beam 802-f, a second communication beam 802-g, a third communication beam 802-h, and a fourth communication beam 802-i. The STA 104-c may compare the receive power metrics with previously-measured (e.g., and stored) receive power metrics for the ASR frames. For example, the STA 104-c may compare the current receive power metric for an ASR frame corresponding to a sector (and communication beam) with a previous receive power metric received for an ASR frame corresponding to the same sector (and same communication beam). If a first receive power metric has decreased for the active communication beam 802-h but a second receive power metric has remained the same or increased for another communication beam, such as the communication beam 802-g, the STA 104-c may determine (e.g., identify, predict, detect) that its beam orientation has changed with respect to the AP 102-d. The STA 104-c may trigger retraining based on determining the change in beam orientation. For example, if the ASR frame corresponding to the communication beam 802-g now has a relatively stronger receive power metric (e.g., RSSI) than the ASR frame corresponding to the communication beam 802-h, the STA 104-c may trigger beam training and the AP 102-d may update to use the communication beam 802-g for the directional link 804-b with the STA 104-c based on the STA mobility.

FIG. 8C shows an example of handling wireless STA mobility 800-c that supports ML aided beam training for IMMW operation. The STA 104-d may be an example of the STA 104-b after moving locations 806-b. The AP 102-e may be an example of the AP 102-c. The AP 102-e and the STA 104-d may communicate via a directional link 804-c (e.g., corresponding to the 60 GHz frequency band). The STA 104-d (e.g., a 60 GHz non-AP STA) may monitor one or more ATPs, or other time windows supporting AP sector sweeps, to measure receive power metrics (e.g., RSSI values) for the ASR frames.

For example, the STA 104-d may remeasure receive power metrics for ASR frames after moving locations 806-b. The STA 104-d may communicate via a communication beam 802-o at the STA 104-d and a communication beam 802-m at the AP 102-e for the directional link 804-c. After moving locations 806-b, the STA 104-d may monitor for the ASR frames. In some examples, the STA 104-d may have moved out of range and may fail to receive any ASR frames. In some other examples, the STA 104-d may receive one or more ASR frames, such as an ASR frame via a third communication beam 802-m and an ASR frame via a fourth communication beam 802-n. The STA 104-d may fail to receive ASR frames via a first communication beam 802-k and a second communication beam 802-l. The STA 104-d may compare the receive power metrics for the received ASR frames with previously-measured (e.g., and stored) receive power metrics for the ASR frames. For example, the STA 104-d may compare the current receive power metric for an ASR frame corresponding to a sector (and communication beam) with a previous receive power metric received for an ASR frame corresponding to the same sector (and same communication beam). If the receive power metrics have decreased for each ASR frame received (e.g., including via the active communication beam 802-m), the STA 104-d may determine (e.g., identify, predict, detect) that it has moved farther away from the AP 102-e. In some examples, the STA 104-d may trigger a reachability measurement based on determining that the STA 104-d has moved away from the AP 102-e. For example, if the strongest receive power metric for the received ASR frames fails to satisfy a threshold value (e.g., a reachability threshold that supports reliable communication between the STA 104-d and the AP 102-e), the STA 104-d may determine (e.g., detect, indicate) a loss of reachability for the directional link 804-c (e.g., the 60 GHz link). The STA 104-d may delete the directional link 804-c from its ML association with the AP 102-e. In some implementations, the STA 104-d may fall back to communicating with the AP 102-e via an omni-directional link (e.g., a sub7 link that is included in the ML association). In some other implementations, the STA 104-d may search for another AP MLD to associate with based on deleting the directional link 804-c.

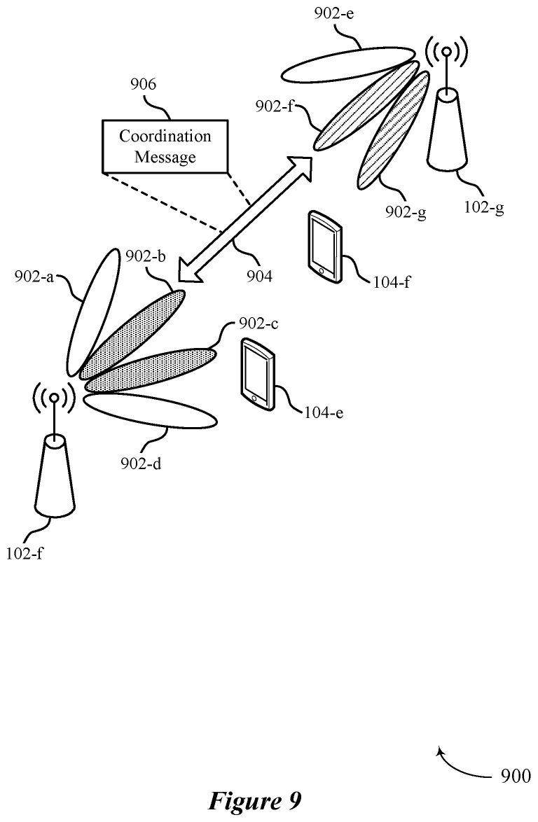

FIG. 9 shows an example of AP coordination 900 that supports ML aided beam training for IMMW operation. A first AP 102-f and a second AP 102-g may be examples of neighboring AP MLDs. The first AP 102-f and the second AP 102-g may be examples of APs 102 as described with reference to FIGS. 1 and 5-8. The AP 102-f may communicate with a STA 104-e via a frequency band that supports directional communications (e.g., a 60 GHz frequency band), and the AP 102-g may communicate with a STA 104-f via the frequency band that supports directional communications (e.g., the 60 GHz frequency band). The STA 104-e and the STA 104-f may be examples of STAs 104 as described with reference to FIGS. 1 and 5-8. The APs 102 (e.g., AP MLDs) may monitor for messages (e.g., ASR messages) from other APs 102 to mitigate potential interference between APs 102.

For example, the AP 102-f (e.g., a first AP MLD) may listen to (e.g., monitor) the 60 GHz medium during an ATP for the AP 102-g (e.g., a second AP MLD). In some examples, the AP 102-f may determine the ATP based on receiving a frame indicating information (e.g., timing information) from the AP 102-g (e.g., via a sub7 frequency band). In some other examples, the APs 102 may coordinate ATPs, such that APs 102 are aware of ATPs for neighboring APs 102 (e.g., APs 102 within a threshold distance). The AP 102-f may determine if it detects (e.g., hears, receives) any ASR messages from the AP 102-g. If the AP 102-f detects one or more ASR messages from the AP 102-g, the AP 102-f may identify (e.g., determine) which sectors or communication beams may experience interference from the AP 102-g. For example, the AP 102-f may receive an ASR message via the communication beam 902-f and an ASR message via the communication beam 902-g, but the AP 102-f may not receive an ASR message via the communication beam 902-e. The AP 102-f may monitor for the ASR messages directionally or omni-directionally. The AP 102-f may determine that one or more of the ASR frames are detected via the communication beam 902-b and the communication beam 902-c but not via the communication beam 902-a or the communication beam 902-d.

The AP 102-f may schedule communications based on detecting the ASR messages from the AP 102-g. In some examples, the AP 102-f may adjust its schedule of service periods (e.g., D-SPs, O-SPs, or both) without coordinating with the AP 102-g. For example, the AP 102-f may apply one or more machine learning (ML) techniques to determine interfering service periods with the AP 102-g based on the received ASR messages and corresponding sectors. The AP 102-f may adjust a schedule of service periods based on an output of the one or more ML techniques.

In some other examples, the AP 102-f may coordinate with the AP 102-g to mitigate interference. For example, the AP 102-f and the AP 102-g may communicate one or more coordination messages 906 to coordinate scheduling based on the received ASR messages and corresponding sectors. The AP 102-f or the AP 102-g may transmit a coordination message 906 via a sub7 link 904 (e.g., to support cross-link multi-AP coordination). For example, the coordination message 906 may indicate a service period schedule, affected sector IDs, or both for an AP 102.

Adjusting a service period schedule may involve adjusting timing, STAs 104, or both for communications. For example, the AP 102-f may orthogonalize, in the time domain, a service period schedule during which the AP 102-f serves (e.g., communicates with) a STA 104-e via a sector that causes interference with the AP 102-g orienting its beams towards the AP 102-f (e.g., to communicate with the STA 104-f). Additionally, or alternatively, the AP 102-f may change which STA 104 it will serve such that the AP 102-f refrains from communicating with the STA 104-e during a same time that the AP 102-g is communication with the STA 104-f (e.g., via interfering sectors). For example, concurrent with the AP 102-g communicating with the STA 104-f, the AP 102-f may communicate with a different STA 104 via a sector that does not interfere with the AP 102-g communicating with the STA 104-f.

In some examples, the APs 102 may coordinate to perform an intelligent allocation of resources (e.g., service periods, STAs 104, beams, sectors) such that STAs 104 are not served via interfering beams within overlapping service periods. In some implementations, the APs 102 may map corresponding beams or sectors to determine (e.g., indicate, store) which beams interfere with which other beams. For example, the AP 102-f may map communication beam 902-b to communication beam 902-f at AP 102-g. Mapping the beam correlations may involve a beam training procedure between the APs 102. For example, during a dedicated time (e.g., a service period, such as an O-SP coordinated between the APs 102), the AP 102-g may transmit a signal (e.g., an ASR message or other signal) via a single beam (e.g., the communication beam 902-f) while the AP 102-f sweeps through receive beams to determine which beams are affected by the single beam. Additionally, or alternatively, the AP 102-f may monitor via a single beam (e.g., the communication beam 902-b) while the AP 102-g sweeps through transmit beams to determine which beams affect the single beam. In some implementations, the APs 102 may share information relating to BI organization, such as the service periods configured within the BIs and the sector IDs for the service periods. The neighboring APs 102 may determine whether they have similar (e.g., partially or fully overlapping in the time domain) BI organizations, such as with regard to service periods, and may determine whether the BI organizations indicate potential beam conflicts or interference (e.g., based on the STAs 104 scheduled for communication in overlapping service periods). The APs 102 may allocate STAs 104 (e.g., for which serving beam IDs have been selected) for communications in service periods to mitigate (e.g., minimize, avoid) beam interference. If a STA 104 reports relatively high interference (e.g., regularly, such as using CSI reporting, a data frame, a BA frame management frame, or some other frame exchange), an AP 102 may trigger a reallocation of scheduling resources to mitigate potential conflicting beams.

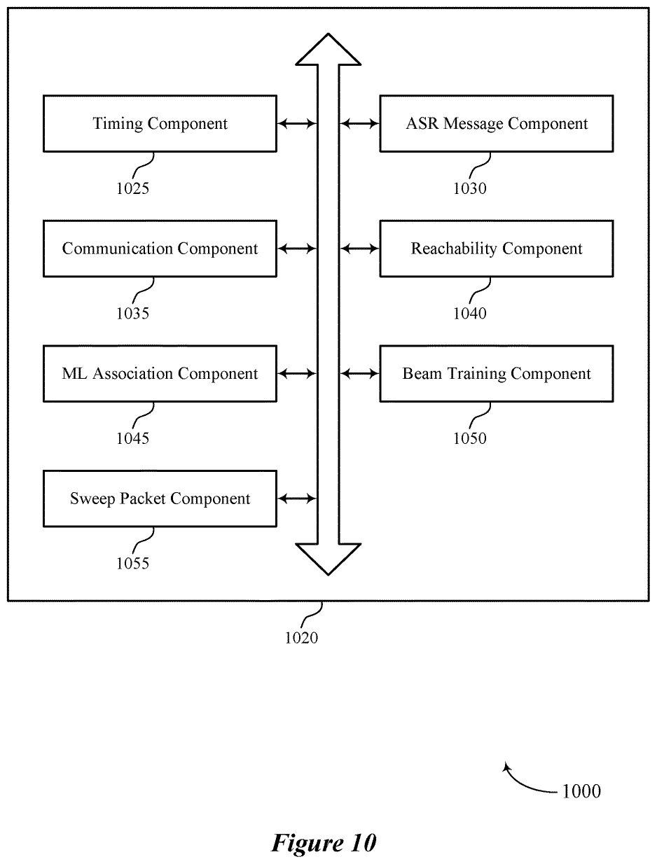

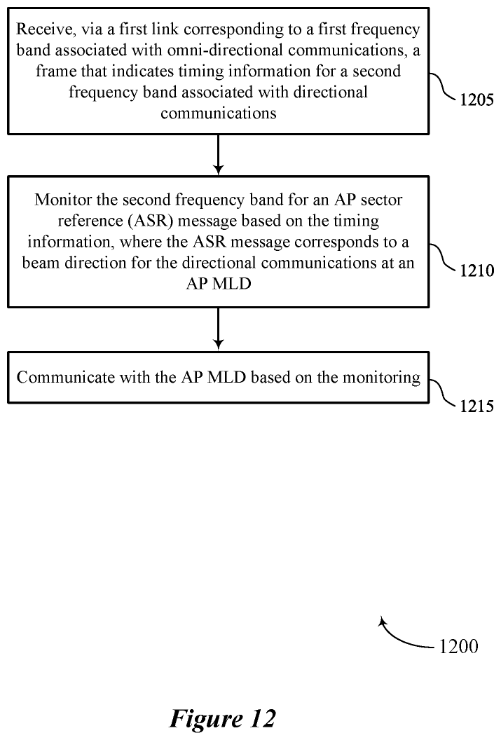

FIG. 10 shows a block diagram of an example wireless communication device 1000 that supports ML aided beam training for IMMW operation. In some examples, the wireless communication device 1000 is configured to perform the process 1200 described with reference to FIG. 12. The wireless communication device 1000 may include one or more chips, systems-on-chips (SoCs), chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA (e.g., a STA MLD or non-AP MLD), such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a timing component 1025, an ASR message component 1030, a communication component 1035, a reachability component 1040, an ML association component 1045, a beam training component 1050, and a sweep packet component 1055. Portions of one or more of the timing component 1025, the ASR message component 1030, the communication component 1035, the reachability component 1040, the ML association component 1045, the beam training component 1050, and the sweep packet component 1055 may be implemented at least in part in hardware or firmware. For example, one or more of the timing component 1025, the ASR message component 1030, the communication component 1035, the reachability component 1040, the ML association component 1045, the beam training component 1050, and the sweep packet component 1055 may be implemented at least in part by at least a processor or a modem. In some examples, portions of one or more of the timing component 1025, the ASR message component 1030, the communication component 1035, the reachability component 1040, the ML association component 1045, the beam training component 1050, and the sweep packet component 1055 may be implemented at least in part by a processor and software in the form of processor-executable code stored in memory.

The wireless communication device 1000 may support wireless communication in accordance with examples as disclosed herein. The timing component 1025 is configurable or configured to receive, via a first link corresponding to a first frequency band associated with omni-directional communications, a frame that indicates information (e.g., timing information) for a second frequency band associated with directional communications. The ASR message component 1030 is configurable or configured to monitor the second frequency band for a message (e.g., an ASR message) based on the information (e.g., the timing information), where the message (e.g., the ASR message) corresponds to a beam direction for the directional communications at an AP MLD and indicates a transmit power of the message. The communication component 1035 is configurable or configured to communicate with the AP MLD based on the monitoring.

In some examples, the ASR message component 1030 is configurable or configured to receive, via the second frequency band, the message based on the monitoring. In some examples, the reachability component 1040 is configurable or configured to determine a reachability of a second link corresponding to the second frequency band based on a receive power of the message, the transmit power of the message, or both.

In some examples, to support communicating, the reachability component 1040 is configurable or configured to communicate via the second link corresponding to the second frequency band based on the reachability of the second link supporting association between the AP MLD and the non-AP MLD via the second frequency band. In some other examples, to support communicating, the reachability component 1040 is configurable or configured to communicate via the first link corresponding to the first frequency band based on the reachability of the second link failing to support association between the AP MLD and the non-AP MLD via the second frequency band. In some examples, a first reachability of the first link corresponding to the first frequency band is different from the reachability of the second link corresponding to the second frequency band.

In some examples, the ASR message component 1030 is configurable or configured to receive, via the second frequency band, the message based on the monitoring. In some examples, the ML association component 1045 is configurable or configured to establish a multi-link association between the non-AP MLD and the AP MLD that includes a second link corresponding to the second frequency band based on the message. In some other examples, the ML association component 1045 is configurable or configured to add a second link corresponding to the second frequency band to a multi-link association between the non-AP MLD and the AP MLD based on the message.

In some examples, the ML association component 1045 is configurable or configured to delete a second link corresponding to the second frequency band from a multi-link association between the non-AP MLD and the AP MLD based on failing to receive, via the second frequency band, the message based on the monitoring or receiving, via the second frequency band, the message with a receive power that fails to satisfying a reachability threshold based on the monitoring.

In some examples, the ASR message component 1030 is configurable or configured to receive, via the second frequency band, one or more messages based on the monitoring. In some examples, the beam training component 1050 is configurable or configured to perform communication beam training for a second link corresponding to the second frequency band based on the one or more messages.

In some examples, the one or more messages includes a single message corresponding to a first beam direction, and the beam training component 1050 is configurable or configured to select a communication beam for the second link corresponding to the second frequency band based on the first beam direction.

In some examples, the one or more messages includes a set of multiple messages corresponding to a set of multiple respective beam directions for the directional communications at the AP MLD, and the beam training component 1050 is configurable or configured to determine a first message of the set of multiple messages associated with a highest receive power at the non-AP MLD, the first message corresponding to a first beam direction of the set of multiple respective beam directions. In some examples, the one or more messages includes a set of multiple messages corresponding to a set of multiple respective beam directions for the directional communications at the AP MLD, and the beam training component 1050 is configurable or configured to select a communication beam for the second link corresponding to the second frequency band based on the first beam direction.

In some examples, the beam training component 1050 is configurable or configured to communicate, via the first link corresponding to the first frequency band, a request frame that indicates a beam training request for the second link corresponding to the second frequency band, where performing the communication beam training is further based on the request frame.

In some examples, the beam training component 1050 is configurable or configured to communicate, via the first link corresponding to the first frequency band, a response frame that indicates an acceptance of the beam training request, where performing the communication beam training is further based on the response frame.

In some examples, the request frame, the response frame, or both include an action frame, the action frame including a first subfield indicating whether the action frame is associated with a request or a response, a second subfield indicating a request for a subsequent AP sector sweep, a third subfield indicating a service period, the information, or both for performing the communication beam training, a fourth subfield indicating the acceptance of the beam training request, or any combination thereof.

In some examples, the information includes a TSF offset value associated with a second link corresponding to the second frequency band.

In some examples, the message indicates a sector ID, a BSS color, an AP ID, a partial or full TSF value, the transmit power, or any combination thereof.

In some examples, the information indicates a transmission period (e.g., an ATP) for the AP MLD. In some examples, the second frequency band is monitored during at least a portion of the transmission period. In some examples, the information indicates a beacon interval, a transmission period periodicity, a transmission period duration, a transmission period start time, a quantity of AP sectors, a dwell time per AP sector, or any combination thereof. In some examples, the transmission period is common to a set of multiple non-AP MLDs.

In some examples, the sweep packet component 1055 is configurable or configured to transmit a set of multiple sweep packets during a service period associated with the non-AP MLD, where each sweep packet of the set of multiple sweep packets corresponds to a respective beam direction for the directional communications at the non-AP MLD.

In some examples, the timing component 1025 is configurable or configured to transmit a multi-link probe request frame based on the non-AP MLD being unassociated with the AP MLD, where the frame includes a multi-link probe response frame and is received based on the multi-link probe request frame. In some other examples, the frame includes a beacon frame.

In some examples, the information satisfies a threshold value for clock drift between the first link corresponding to the first frequency band and a second link corresponding to the second frequency band.

In some examples, the ASR message component 1030 is configurable or configured to receive, via the second frequency band, a set of multiple messages based on the monitoring. In some examples, the beam training component 1050 is configurable or configured to trigger a communication beam switch from an active communication beam to a second communication beam based on a decrease, from a previous transmission period, of a first receive power for a first message corresponding to the active communication beam and an increase, from the previous transmission period, of a second receive power for a second message corresponding to the second communication beam.

In some examples, the ASR message component 1030 is configurable or configured to receive, via the second frequency band, a set of multiple messages based on the monitoring. In some examples, the reachability component 1040 is configurable or configured to determine a loss of reachability of a second link corresponding to the second frequency band based on a decrease, from a previous transmission period, of a respective receive power for each message of the set of multiple messages.

In some examples, the first frequency band includes a sub-7 GHz band. In some such examples, the second frequency band includes a 60 GHz band, a 45 GHz band, or a 28 GHz band.

In some examples, the ASR message component 1030 is configurable or configured to deactivate a first radio or first radio mode associated with a first power level based on operating without a second link corresponding to the second frequency band. In some such examples, the ASR message component 1030 is configurable or configured to active a second radio or second radio mode associated with a second power level based on the information, the second power level being relatively lower than the first power level. In some examples, the ASR message component 1030 is configurable or configured to receive one or more messages using the second radio or the second radio mode. If a link is established or added between the non-AP MLD and the AP MLD via the second frequency band, the ASR message component 1030 is configurable or configured to deactivate the second radio and reactive the first radio to use the first radio for communications via the link.

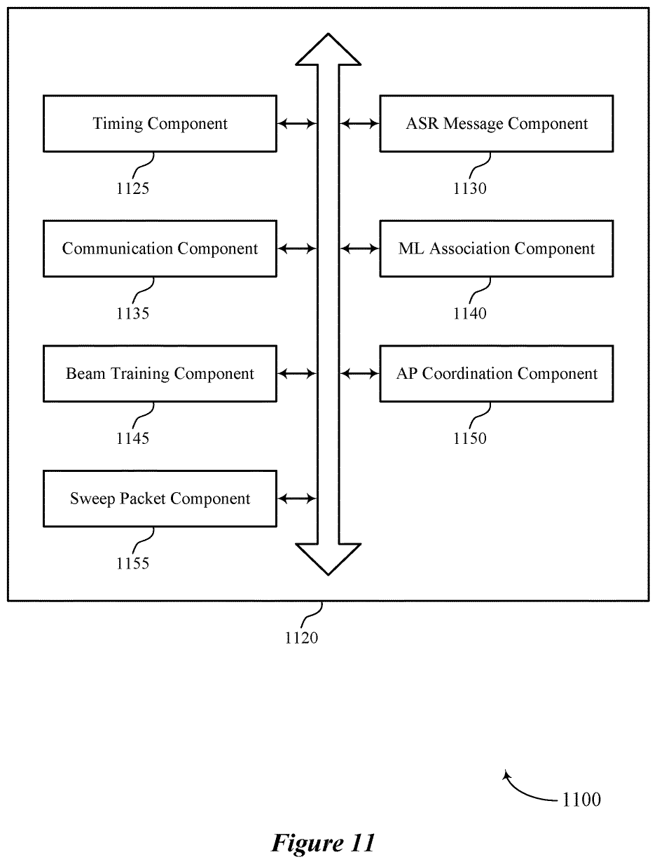

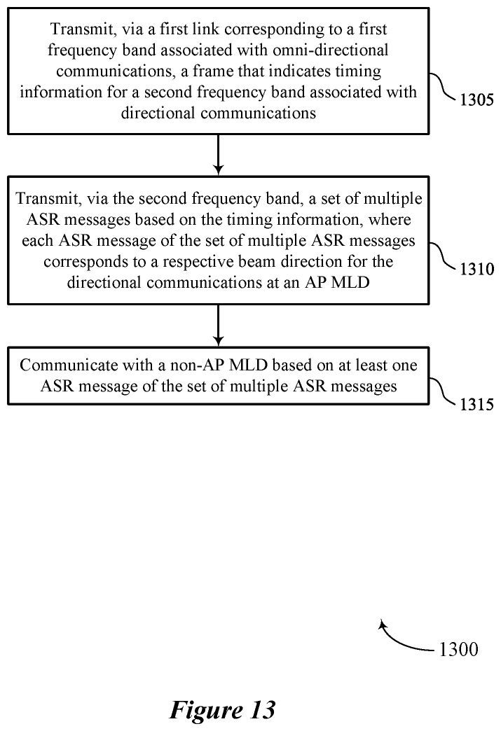

FIG. 11 shows a block diagram of an example wireless communication device 1100 that supports ML aided beam training for IMMW operation. In some examples, the wireless communication device 1100 is configured to perform the process 1300 described with reference to FIG. 13. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP (e.g., an AP MLD), such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a timing component 1125, an ASR message component 1130, a communication component 1135, an ML association component 1140, a beam training component 1145, an AP coordination component 1150, and a sweep packet component 1155. Portions of one or more of the timing component 1125, the ASR message component 1130, the communication component 1135, the ML association component 1140, the beam training component 1145, the AP coordination component 1150, and the sweep packet component 1155 may be implemented at least in part in hardware or firmware. For example, one or more of the timing component 1125, the ASR message component 1130, the communication component 1135, the ML association component 1140, the beam training component 1145, the AP coordination component 1150, and the sweep packet component 1155 may be implemented at least in part by at least a processor or a modem. In some examples, portions of one or more of the timing component 1125, the ASR message component 1130, the communication component 1135, the ML association component 1140, the beam training component 1145, the AP coordination component 1150, and the sweep packet component 1155 may be implemented at least in part by a processor and software in the form of processor-executable code stored in memory.

The wireless communication device 1100 may support wireless communication in accordance with examples as disclosed herein. The timing component 1125 is configurable or configured to transmit, via a first link corresponding to a first frequency band associated with omni-directional communications, a frame that indicates information (e.g., timing information) for a second frequency band associated with directional communications. The ASR message component 1130 is configurable or configured to transmit, via the second frequency band, a set of multiple messages (e.g., a set of multiple ASR messages) based on the information, where each message of the set of multiple messages corresponds to a respective beam direction for the directional communications at the AP MLD. In some examples, each message may indicate a respective message transmit power. The communication component 1135 is configurable or configured to communicate with a non-AP MLD based on at least one message of the set of multiple messages.

In some examples, the ML association component 1140 is configurable or configured to establish a multi-link association between the AP MLD and the non-AP MLD that includes a second link corresponding to the second frequency band based on the at least one message. In some other examples, the ML association component 1140 is configurable or configured to add a second link corresponding to the second frequency band to a multi-link association between the AP MLD and the non-AP MLD based on the at least one message. In yet some other examples, the ML association component 1140 is configurable or configured to delete a second link corresponding to the second frequency band from a multi-link association between the AP MLD and the non-AP MLD based on the at least one message.

In some examples, the beam training component 1145 is configurable or configured to perform communication beam training for a second link corresponding to the second frequency band based on the set of multiple messages.

In some examples, the beam training component 1145 is configurable or configured to communicate, via the first link corresponding to the first frequency band, a request frame that indicates a beam training request for the second link corresponding to the second frequency band, where performing the communication beam training is further based on the request frame. In some examples, the beam training component 1145 is configurable or configured to communicate, via the first link corresponding to the first frequency band, a response frame that indicates an acceptance of the beam training request, where performing the communication beam training is further based on the response frame.

In some examples, the request frame, the response frame, or both include an action frame, the action frame including a first subfield indicating whether the action frame is associated with a request or a response, a second subfield indicating a request for a subsequent AP sector sweep, a third subfield indicating a service period, the information (e.g., the timing information), or both for performing the communication beam training, a fourth subfield indicating the acceptance of the beam training request, or any combination thereof.

In some examples, the AP coordination component 1150 is configurable or configured to monitor the second frequency band during a transmission period of another AP MLD. In some examples, the AP coordination component 1150 is configurable or configured to detect one or more messages associated with the other AP MLD based on the monitoring, the one or more messages further associated with one or more sectors at the AP MLD. In some examples, the AP coordination component 1150 is configurable or configured to scheduling communications for the one or more sectors at the AP MLD base at least in part on detecting the one or more messages.

In some examples, the AP coordination component 1150 is configurable or configured to communicate, with the other AP MLD via the first frequency band, a coordination frame that indicates the one or more sectors, scheduling information for the one or more sectors, or both.

In some examples, the information includes a TSF offset value associated with a second link corresponding to the second frequency band.

In some examples, the at least one message indicates a sector ID, a BSS color, an AP ID, a partial or full TSF value, a transmit power, or any combination thereof.

In some examples, the information indicates a transmission period (e.g., an ATP) for the AP MLD. In some examples, the set of multiple messages is transmitted during at least a portion of the transmission period. In some examples, the information indicates a beacon interval, a transmission period periodicity, a transmission period duration, a transmission period start time, a quantity of AP sectors, a dwell time per AP sector, or any combination thereof. In some examples, the transmission period is common to a set of multiple non-AP MLDs.

In some examples, the sweep packet component 1155 is configurable or configured to monitor the second frequency band for a sweep packet during a service period associated with the non-AP MLD, where the sweep packet corresponds to a beam direction for the directional communications at the non-AP MLD.

In some examples, the timing component 1125 is configurable or configured to receive a multi-link probe request frame based on the non-AP MLD being unassociated with the AP MLD, where the frame includes a multi-link probe response frame and is transmitted based on the multi-link probe request frame. In some other examples, the frame includes a beacon frame.

In some examples, the information satisfies a threshold value for clock drift between the first link corresponding to the first frequency band and a second link corresponding to the second frequency band.

In some examples, the first frequency band includes a sub-7 GHz band. In some such examples, the second frequency band includes a 60 GHz band, a 45 GHz band, or a 28 GHz band.

FIG. 12 shows a flowchart illustrating an example process 1200 performable by or at a non-AP MLD that supports ML aided beam training for IMMW operation. The operations of the process 1200 may be implemented by a non-AP MLD or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1205, the non-AP MLD may receive, via a first link corresponding to a first frequency band associated with omni-directional communications, a frame that indicates information (e.g., timing information) for a second frequency band associated with directional communications. In some implementations, aspects of the operations of 1205 may be performed by a timing component 1025 as described with reference to FIG. 10.

In some examples, in 1210, the non-AP MLD may monitor the second frequency band for a message (e.g., an ASR message) based on the information, where the message corresponds to a beam direction for the directional communications at an AP MLD. In some examples, the message may indicate a transmit power of the message In some implementations, aspects of the operations of 1210 may be performed by an ASR message component 1030 as described with reference to FIG. 10.

In some examples, in 1215, the non-AP MLD may communicate with the AP MLD based on the monitoring. In some implementations, aspects of the operations of 1215 may be performed by a communication component 1035 as described with reference to FIG. 10.

FIG. 13 shows a flowchart illustrating an example process 1300 performable by or at an AP MLD that supports ML aided beam training for IMMW operation. The operations of the process 1300 may be implemented by an AP MLD or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the AP MLD may transmit, via a first link corresponding to a first frequency band associated with omni-directional communications, a frame that indicates information (e.g., timing information) for a second frequency band associated with directional communications. In some implementations, aspects of the operations of 1305 may be performed by a timing component 1125 as described with reference to FIG. 11.

In some examples, in 1310, the AP MLD may transmit, via the second frequency band, a set of multiple messages (e.g., a set of multiple ASR messages) based on the information, where each ASR message of the set of multiple ASR messages corresponds to a respective beam direction for the directional communications at the AP MLD. In some examples, each message may indicate a respective message transmit power. In some implementations, aspects of the operations of 1310 may be performed by an ASR message component 1130 as described with reference to FIG. 11.

In some examples, in 1315, the AP MLD may communicate with a non-AP MLD based on at least one ASR message of the set of multiple ASR messages. In some implementations, aspects of the operations of 1315 may be performed by a communication component 1135 as described with reference to FIG. 11.

The following provides an overview of aspects of the present disclosure:

Aspect 1: A method for wireless communication at a non-AP MLD, comprising: receiving, via a first link corresponding to a first frequency band associated with omni-directional communications, a frame that indicates information (e.g., timing information) for a second frequency band associated with directional communications; monitoring the second frequency band for a message (e.g., an ASR message) based at least in part on the information, wherein the message corresponds to a beam direction for the directional communications at an AP MLD and indicates at least one of a transmit power of the message, a sector ID, a BSS color, an AP ID, or a partial or full TSF value; and communicating with the AP MLD based at least in part on the monitoring.

Aspect 2: The method of aspect 1, further comprising: receiving, via the second frequency band, the message based at least in part on the monitoring; and determining a reachability of a second link corresponding to the second frequency band based at least in part on a receive power of the message, the transmit power of the message, or both, wherein, to communicate, the method comprises: communicate with the AP LD based at least in part on the reachability of the second link.

Aspect 3: The method of aspect 2, wherein the communicating comprises: communicating via the second link corresponding to the second frequency band based at least in part on the reachability of the second link supporting association between the AP MLD and the non-AP MLD via the second frequency band.

Aspect 4: The method of aspect 2, wherein the communicating comprises: communicating via the first link corresponding to the first frequency band based at least in part on the reachability of the second link failing to support association between the AP MLD and the non-AP MLD via the second frequency band.

Aspect 5: The method of any of aspects 2 through 4, wherein a first reachability of the first link corresponding to the first frequency band is different from the reachability of the second link corresponding to the second frequency band.

Aspect 6: The method of any of aspects 1 through 5, further comprising: receiving, via the second frequency band, the message based at least in part on the monitoring; and establishing a multi-link association between the non-AP MLD and the AP MLD that comprises a second link corresponding to the second frequency band based at least in part on the message.

Aspect 7: The method of any of aspects 1 through 5, further comprising: receiving, via the second frequency band, the message based at least in part on the monitoring; and adding a second link corresponding to the second frequency band to a multi-link association between the non-AP MLD and the AP MLD based at least in part on the message.

Aspect 8: The method of any of aspects 1 through 5, further comprising: deleting a second link corresponding to the second frequency band from a multi-link association between the non-AP MLD and the AP MLD based at least in part on: failing to receive, via the second frequency band, the message based at least in part on the monitoring, or receiving, via the second frequency band, the message with a receive power that fails to satisfy a reachability threshold based at least in part on the monitoring.

Aspect 9: The method of any of aspects 1 through 8, further comprising: receiving, via the second frequency band, one or more messages based at least in part on the monitoring; and performing communication beam training for a second link corresponding to the second frequency band based at least in part on the one or more messages.

Aspect 10: The method of aspect 9, wherein the one or more messages comprises a single message corresponding to a first beam direction, the method further comprising: selecting a communication beam for the second link corresponding to the second frequency band based at least in part on the first beam direction.

Aspect 11: The method of aspect 9, wherein the one or more messages comprises a plurality of messages corresponding to a plurality of respective beam directions for the directional communications at the AP MLD, each message of the plurality of messages corresponding to a respective beam direction of the plurality of respective beam directions, the method further comprising: determining a first message of the plurality of messages associated with a highest receive power at the non-AP MLD, the first message corresponding to a first beam direction of the plurality of respective beam directions; and selecting a communication beam for the second link corresponding to the second frequency band based at least in part on the first beam direction.

Aspect 12: The method of any of aspects 9 through 11, further comprising: communicating, via the first link corresponding to the first frequency band, a request frame that indicates a beam training request for the second link corresponding to the second frequency band, wherein performing the communication beam training is further based at least in part on the request frame.

Aspect 13: The method of aspect 12, further comprising: communicating, via the first link corresponding to the first frequency band, a response frame that indicates an acceptance of the beam training request, wherein performing the communication beam training is further based at least in part on the response frame.

Aspect 14: The method of aspect 13, wherein the request frame, the response frame, or both comprise an action frame, the action frame comprising: a first subfield indicating whether the action frame is associated with a request or a response, a second subfield indicating a request for a subsequent AP sector sweep, a third subfield indicating a service period, the information, or both for performing the communication beam training, a fourth subfield indicating the acceptance of the beam training request, or any combination thereof.

Aspect 15: The method of any of aspects 1 through 14, wherein the information comprises a TSF offset value associated with a second link corresponding to the second frequency band.

Aspect 16: The method of any of aspects 1 through 15, wherein the message indicates a sector ID, a BSS color, an AP ID, a partial or full TSF value, the transmit power, or any combination thereof.

Aspect 17: The method of any of aspects 1 through 16, wherein the information indicates a transmission period (e.g., an ATP) for the AP MLD; and the second frequency band is monitored during at least a portion of the transmission period.

Aspect 18: The method of aspect 17, wherein the timing information indicates a beacon interval, a transmission period periodicity, a transmission period duration, a transmission period start time, a quantity of AP sectors, a dwell time per AP sector, or any combination thereof.

Aspect 19: The method of any of aspects 17 through 18, wherein the transmission period is common to a plurality of non-AP MLDs.

Aspect 20: The method of any of aspects 1 through 19, further comprising: transmitting a plurality of sweep packets during a service period associated with the non-AP MLD, wherein each sweep packet of the plurality of sweep packets corresponds to a respective beam direction for the directional communications at the non-AP MLD.

Aspect 21: The method of any of aspects 1 through 20, further comprising: transmitting an ML probe request frame based at least in part on the non-AP MLD being unassociated with the AP MLD, wherein the frame comprises an ML probe response frame and is received based at least in part on the ML probe request frame.

Aspect 22: The method of any of aspects 1 through 20, wherein the frame comprises a beacon frame.

Aspect 23: The method of any of aspects 1 through 22, wherein the information satisfies a threshold value for clock drift between the first link corresponding to the first frequency band and a second link corresponding to the second frequency band.

Aspect 24: The method of any of aspects 1 through 23, further comprising: receiving, via the second frequency band, a plurality of messages based at least in part on the monitoring; and triggering a communication beam switch from an active communication beam to a second communication beam based at least in part on a decrease, from a previous transmission period, of a first receive power for a first message corresponding to the active communication beam and an increase, from the previous transmission period, of a second receive power for a second message corresponding to the second communication beam.

Aspect 25: The method of any of aspects 1 through 23, further comprising: receiving, via the second frequency band, a plurality of messages based at least in part on the monitoring; determining a loss of reachability of a second link corresponding to the second frequency band based at least in part on a decrease, from a previous transmission period, of a respective receive power for each message of the plurality of messages; and deleting the second link from a multi-link association between the non-AP MLD and the AP MLD based at least in part on the loss of reachability of the second link.

Aspect 26: The method of any of aspects 1 through 25, wherein the first frequency band comprises a sub-7 GHz band; and the second frequency band comprises a 60 GHz band, a 45 GHz band, or a 28 GHz band.

Aspect 27: A method for wireless communication at an AP MLD, comprising: transmitting, via a first link corresponding to a first frequency band associated with omni-directional communications, a frame that indicates information (e.g., timing information) for a second frequency band associated with directional communications; transmitting, via the second frequency band, a plurality of messages (e.g., ASR messages) based at least in part on the information, wherein each message of the plurality of messages corresponds to a respective beam direction for the directional communications at the AP MLD and indicates at least one of a respective message transmit power, a respective sector ID, a respective BSS color, a respective AP ID, or a respective partial or full TSF value; and communicating with a non-AP MLD based at least in part on at least one message of the plurality of messages.

Aspect 28: The method of aspect 27, further comprising: establishing a multi-link association between the AP MLD and the non-AP MLD that comprises a second link corresponding to the second frequency band based at least in part on the at least one message.

Aspect 29: The method of aspect 27, further comprising: adding a second link corresponding to the second frequency band to a multi-link association between the AP MLD and the non-AP MLD based at least in part on the at least one message.

Aspect 30: The method of aspect 27, further comprising: deleting a second link corresponding to the second frequency band from a multi-link association between the AP MLD and the non-AP MLD based at least in part on the at least one message.

Aspect 31: The method of any of aspects 27 through 30, further comprising: performing communication beam training for a second link corresponding to the second frequency band based at least in part on the plurality of messages.

Aspect 32: The method of aspect 31, further comprising: communicating, via the first link corresponding to the first frequency band, a request frame that indicates a beam training request for the second link corresponding to the second frequency band, wherein performing the communication beam training is further based at least in part on the request frame.

Aspect 33: The method of aspect 32, further comprising: communicating, via the first link corresponding to the first frequency band, a response frame that indicates an acceptance of the beam training request, wherein performing the communication beam training is further based at least in part on the response frame.

Aspect 34: The method of aspect 33, wherein the request frame, the response frame, or both comprise an action frame, the action frame comprising: a first subfield indicating whether the action frame is associated with a request or a response, a second subfield indicating a request for a subsequent AP sector sweep, a third subfield indicating a service period, the information, or both for performing the communication beam training, a fourth subfield indicating the acceptance of the beam training request, or any combination thereof.

Aspect 35: The method of any of aspects 27 through 34, further comprising: monitoring the second frequency band during a transmission period of another AP MLD; detecting one or more messages associated with the other AP MLD based at least in part on the monitoring, the one or more messages further associated with one or more sectors at the AP MLD; and scheduling communications for the one or more sectors at the AP MLD based at least in part on detecting the one or more messages.

Aspect 36: The method of aspect 35, further comprising: communicating, with the other AP MLD via the first frequency band, a coordination frame that indicates the one or more sectors, scheduling information for the one or more sectors, or both.

Aspect 37: The method of any of aspects 27 through 36, wherein the information comprises a TSF offset value associated with a second link corresponding to the second frequency band.

Aspect 38: The method of any of aspects 27 through 37, wherein the at least one message indicates a sector ID, a BSS color, an AP ID, a partial or full TSF value, the transmit power, or any combination thereof.

Aspect 39: The method of any of aspects 27 through 38, wherein the information indicates a transmission period (e.g., an ATP) for the AP MLD; and the plurality of messages is transmitted during at least a portion of the transmission period.

Aspect 40: The method of aspect 39, wherein the information indicates a beacon interval, a transmission period periodicity (e.g., an ATP periodicity), a transmission period duration (e.g., an ATP duration), a transmission period start time (e.g., an ATP start time), a quantity of AP sectors, a dwell time per AP sector, or any combination thereof.

Aspect 41: The method of any of aspects 39 through 40, wherein the transmission period is common to a plurality of non-AP MLDs.

Aspect 42: The method of any of aspects 27 through 41, further comprising: monitoring the second frequency band for a sweep packet during a service period associated with the non-AP MLD, wherein the sweep packet corresponds to a beam direction for the directional communications at the non-AP MLD.

Aspect 43: The method of any of aspects 27 through 42, further comprising: receiving a multi-link probe request frame based at least in part on the non-AP MLD being unassociated with the AP MLD, wherein the frame comprises a multi-link probe response frame and is transmitted based at least in part on the multi-link probe request frame.

Aspect 44: The method of any of aspects 27 through 43, wherein the frame comprises a beacon frame.

Aspect 45: The method of any of aspects 27 through 44, wherein the information satisfies a threshold value for clock drift between the first link corresponding to the first frequency band and a second link corresponding to the second frequency band.

Aspect 46: The method of any of aspects 27 through 45, wherein the first frequency band comprises a sub-7 GHz band; and the second frequency band comprises a 60 GHz band, a 45 GHz band, or a 28 GHz band.

Aspect 47: A non-AP MLD for wireless communication, comprising a processing system that includes processor circuitry and memory circuitry that stores code, the processing system configured to cause the non-AP MLD to perform a method of any of aspects 1 through 26.

Aspect 48: A non-AP MLD, comprising at least one means for performing a method of any of aspects 1 through 26.

Aspect 49: A non-transitory computer-readable medium storing code for wireless communication, the code comprising instructions executable by one or more processors to perform a method of any of aspects 1 through 26.

Aspect 50: An AP MLD for wireless communication, comprising a processing system that includes processor circuitry and memory circuitry that stores code, the processing system configured to cause the AP MLD to perform a method of any of aspects 27 through 46.

Aspect 51: An AP MLD, comprising at least one means for performing a method of any of aspects 27 through 46.

Aspect 52: A non-transitory computer-readable medium storing code for wireless communication, the code comprising instructions executable by one or more processors to perform a method of any of aspects 27 through 46.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A non-access point (AP) multi-link device (MLD), comprising:
a processing system that includes processor circuitry and memory circuitry that stores code, the processing system configured to cause the non-AP MLD to:
receive, via a first link corresponding to a first frequency band associated with omni-directional communications, a frame that indicates information for a second frequency band associated with directional communications;
monitor the second frequency band for a message based at least in part on the information, wherein the message corresponds to a beam direction for the directional communications at an AP MLD and indicates at least one of a transmit power of the message, a sector identifier (ID), a basic service set (BSS) color, an AP ID, or a partial or full timing synchronization function (TSF) value; and
communicate with the AP MLD based at least in part on the second frequency band being monitored.

2. The non-AP MLD of claim 1, wherein the processing system is further configured to cause the non-AP MLD to:
receive, via the second frequency band, the message based at least in part on the second frequency band being monitored; and
determine a reachability of a second link corresponding to the second frequency band based at least in part on a receive power of the message, the transmit power of the message, or both,
wherein, to communicate with the AP MLD, the processing system is configured to cause the non-AP MLD to:
communicate with the AP MLD based at least in part on the reachability of the second link.

3. The non-AP MLD of claim 2, wherein, to communicate with the AP MLD, the processing system is configured to cause the non-AP MLD to:
communicate via the second link corresponding to the second frequency band based at least in part on the reachability of the second link supporting association between the AP MLD and the non-AP MLD via the second frequency band.

4. The non-AP MLD of claim 2, wherein, to communicate with the AP MLD, the processing system is configured to cause the non-AP MLD to:
communicate via the first link corresponding to the first frequency band based at least in part on the reachability of the second link failing to support association between the AP MLD and the non-AP MLD via the second frequency band.

5. The non-AP MLD of claim 2, wherein a first reachability of the first link corresponding to the first frequency band is different from the reachability of the second link corresponding to the second frequency band.

6. The non-AP MLD of claim 1, wherein the processing system is further configured to cause the non-AP MLD to:
receive, via the second frequency band, the message based at least in part on the second frequency band being monitored; and
establish a multi-link association between the non-AP MLD and the AP MLD that comprises a second link corresponding to the second frequency band based at least in part on the message.

7. The non-AP MLD of claim 1, wherein the processing system is further configured to cause the non-AP MLD to:
receive, via the second frequency band, the message based at least in part on the second frequency band being monitored; and
add a second link corresponding to the second frequency band to a multi-link association between the non-AP MLD and the AP MLD based at least in part on the message.

8. The non-AP MLD of claim 1, wherein the processing system is further configured to cause the non-AP MLD to:
delete a second link corresponding to the second frequency band from a multi-link association between the non-AP MLD and the AP MLD based at least in part on:
failure to receive, via the second frequency band, the message based at least in part on the second frequency band being monitored, or
reception of, via the second frequency band, the message with a receive power that fails to satisfy a reachability threshold based at least in part on the second frequency band being monitored.

9. The non-AP MLD of claim 1, wherein the processing system is further configured to cause the non-AP MLD to:
receive, via the second frequency band, one or more messages based at least in part on the second frequency band being monitored; and
perform communication beam training for a second link corresponding to the second frequency band based at least in part on the one or more messages.

10. The non-AP MLD of claim 9, wherein the one or more messages comprises a single message corresponding to a first beam direction, and the processing system is further configured to cause the non-AP MLD to:
select a communication beam for the second link corresponding to the second frequency band based at least in part on the first beam direction.

11. The non-AP MLD of claim 9, wherein the one or more messages comprises a plurality of messages corresponding to a plurality of respective beam directions for the directional communications at the AP MLD, and the processing system is further configured to cause the non-AP MLD to:
determine a first message of the plurality of messages associated with a highest receive power at the non-AP MLD, the first message corresponding to a first beam direction of the plurality of respective beam directions; and
select a communication beam for the second link corresponding to the second frequency band based at least in part on the first beam direction.

12. The non-AP MLD of claim 9, wherein the processing system is further configured to cause the non-AP MLD to:
communicate, via the first link corresponding to the first frequency band, a request frame that indicates a beam training request for the second link corresponding to the second frequency band, wherein performance of the communication beam training is further based at least in part on the request frame.

13. The non-AP MLD of claim 12, wherein the processing system is further configured to cause the non-AP MLD to:
communicate, via the first link corresponding to the first frequency band, a response frame that indicates an acceptance of the beam training request, wherein the performance of the communication beam training is further based at least in part on the response frame.

14. The non-AP MLD of claim 13, wherein the request frame, the response frame, or both comprise an action frame, the action frame comprising:
a first subfield indicating whether the action frame is associated with a request or a response,
a second subfield indicating a request for a subsequent AP sector sweep,
a third subfield indicating a service period, the information, or both for the performance of the communication beam training,
a fourth subfield indicating the acceptance of the beam training request, or
any combination thereof.

15. The non-AP MLD of claim 1, wherein the information comprises a TSF offset value associated with a second link corresponding to the second frequency band.

16. The non-AP MLD of claim 1, wherein:
the information indicates a transmission period for the AP MLD; and
the second frequency band is monitored during at least a portion of the transmission period.

17. The non-AP MLD of claim 16, wherein the information indicates a beacon interval, a transmission period periodicity, a transmission period duration, a transmission period start time, a quantity of AP sectors, a dwell time per AP sector, or any combination thereof.

18. The non-AP MLD of claim 16, wherein the transmission period is common to a plurality of non-AP MLDs.

19. The non-AP MLD of claim 1, wherein the processing system is further configured to cause the non-AP MLD to:
transmit a plurality of sweep packets during a service period associated with the non-AP MLD, wherein each sweep packet of the plurality of sweep packets corresponds to a respective beam direction for the directional communications at the non-AP MLD.

20. The non-AP MLD of claim 1, wherein the processing system is further configured to cause the non-AP MLD to:
transmit a multi-link probe request frame based at least in part on the non-AP MLD being unassociated with the AP MLD, wherein the frame comprises a multi-link probe response frame and is received based at least in part on the multi-link probe request frame.

21. The non-AP MLD of claim 1, wherein the frame comprises a beacon frame.

22. The non-AP MLD of claim 1, wherein the information satisfies a threshold value for clock drift between the first link corresponding to the first frequency band and a second link corresponding to the second frequency band.

23. The non-AP MLD of claim 1, wherein the processing system is further configured to cause the non-AP MLD to:
receive, via the second frequency band, a plurality of messages based at least in part on the second frequency band being monitored; and
trigger a communication beam switch from an active communication beam to a second communication beam based at least in part on a decrease, from a previous transmission period, of a first receive power for a first message corresponding to the active communication beam and an increase, from the previous transmission period, of a second receive power for a second message corresponding to the second communication beam.

24. The non-AP MLD of claim 1, wherein the processing system is further configured to cause the non-AP MLD to:
receive, via the second frequency band, a plurality of messages based at least in part on the second frequency band being monitored;
determine a loss of reachability of a second link corresponding to the second frequency band based at least in part on a decrease, from a previous transmission period, of a respective receive power for each message of the plurality of messages; and
delete the second link from a multi-link association between the non-AP MLD and the AP MLD based at least in part on the loss of reachability of the second link.

25. The non-AP MLD of claim 1, wherein:
the first frequency band comprises a sub-7 Gigahertz (GHz) band; and
the second frequency band comprises a 60 GHz band, a 45 GHz band, or a 28 GHz band.

26. An access point (AP) multi-link device (MLD), comprising:
a processing system that includes processor circuitry and memory circuitry that stores code, the processing system configured to cause the AP MLD to:
transmit, via a first link corresponding to a first frequency band associated with omni-directional communications, a frame that indicates information for a second frequency band associated with directional communications;
transmit, via the second frequency band, a plurality of messages based at least in part on the information, wherein each message of the plurality of messages corresponds to a respective beam direction for the directional communications at the AP MLD and indicates at least one of a respective message transmit power, a respective sector identifier (ID), a respective basic service set (BSS) color, a respective AP ID, or a respective partial or full timing synchronization function (TSF) value; and
communicate with a non-AP MLD based at least in part on at least one message of the plurality of messages.

27. The AP MLD of claim 26, wherein the information comprises a TSF offset value associated with a second link corresponding to the second frequency band.

28. The AP MLD of claim 26, wherein the information indicates a beacon interval, a transmission period periodicity, a transmission period duration, a transmission period start time, a quantity of AP sectors, a dwell time per AP sector, or any combination thereof.

29. A method for wireless communication at a non-access point (AP) multi-link device (MLD), comprising:
receiving, via a first link corresponding to a first frequency band associated with omni-directional communications, a frame that indicates information for a second frequency band associated with directional communications;
monitoring the second frequency band for a message based at least in part on the information, wherein the message corresponds to a beam direction for the directional communications at an AP MLD and indicates at least one of a transmit power of the message, a sector identifier (ID), a basic service set (BSS) color, an AP ID, or a partial or full timing synchronization function (TSF) value; and
communicating with the AP MLD based at least in part on the monitoring.

30. A method for wireless communication at an access point (AP) multi-link device (MLD), comprising:
transmitting, via a first link corresponding to a first frequency band associated with omni-directional communications, a frame that indicates information for a second frequency band associated with directional communications;
transmitting, via the second frequency band, a plurality of messages based at least in part on the information, wherein each message of the plurality of messages corresponds to a respective beam direction for the directional communications at the AP MLD and indicates at least one of a respective message transmit power, a respective sector identifier (ID), a respective basic service set (BSS) color, a respective AP ID, or a respective partial or full timing synchronization function (TSF) value; and
communicating with a non-AP MLD based at least in part on at least one message of the plurality of messages.
